(19) United States
(12) Patent Application Publication
(10) Pub. No.: US 2002/0191391 A1
(43) Pub. Date: Dec. 19, 2002

(54) Exterior lighting systems

(76) Inventor: Kurt B. Van Etten, Cave Creek, AZ (US)

Correspondence Address: STONEMAN LAW OFFICES, LTD, 3113 NORTH 3RD STREET, PHOENIX, AZ, 85012, US

(21) Appl. No.: 10/219,432

(22) Filed: Aug. 14, 2002

Related U.S. Application Data
(63) Continuation-in-part of application No. 09/560,302, filed on Apr. 27, 2000.

(51) Int. Cl. F21S 8/00

(52) U.S. Cl. 362/153; 362/267

(57) ABSTRACT

Several matching exterior lighting systems for use on property having electrical service wiring. Lighting fixtures are made of pipe or wood, preferably PVC pipe or redwood. Several embodiments can be installed directly in the ground, while other embodiments can be installed on the vertical exterior surface of a building, or on the top of a wall. In all embodiments, the lamp and electrical connections are housed within the same enclosure and the structure of the lighting fixture provide for direct mounting to the environment without intermediary elements that are not part of the structure, and no separate electrical box is needed. The embodiments made of pipe are coated with stucco, brick, stone, tile, wood, aluminum sheet, or copper sheet, to protect the pipe from environmental degradation and permit greater aesthetic appeal and incorporation into the environment. The preferred coating is stucco, and the invention includes a new method of applying stucco to a circular cylinder and manufacturing an article. The circular embodiments each have a single lens that covers all of the windows. In several embodiments, the fluorescent light and light bulbs can be accessed by removing the top of the light and lifting out the lamp, which is hung from the top.

### CROSS-REFERENCE TO RELATED APPLICATION

The present application is a continuation-in-part of related application Ser. No. 09/560,302, filed Apr. 27, 2000, entitled “EXTERIOR LIGHTING SYSTEMS”, which is incorporated herein by this reference, and which is not admitted to be prior art with respect to the present invention by the mention in this cross-reference section.

### BACKGROUND

This invention relates to systems for providing exterior lighting on real property. More specifically, this invention concerns systems for lighting the exterior of buildings and the surrounding property, collectively the environment, including multi-family dwellings, such as apartment buildings.

Typically, in the prior art, some method of lighting the property surrounding buildings was needed at night. Light was needed for occupants, business invitees, and social guests to see their way into and out of the buildings, and also including light for people to perform work, socially interact, recreate, relax, and perform other legitimate activities outdoors, at night, weather permitting. Lighting the property surrounding buildings and general environment also was needed to prevent burglars and other criminals from using the cover of darkness to sneak around or hide illicit activities.

Since electrical service became available on a widespread basis, electrical lighting has been used to light property, particularly the property surrounding buildings. See, for example, U.S. Pat. No. 1,248,688 to Ludescher. The development of exterior lighting has continued over the years and has included lights and light housings mounted on various-sized poles (see, e.g., U.S. Pat. No. 3,257,496 to Hamilton), lights and light housings mounted close to the ground (see, e.g., U.S. Pat. No. 3,798,438 to Manechetti), light housings mounted on fences (see, e.g., U.S. Pat. No. 1,794,467 to Lucas and U.S. Pat. No. 3,679,891 to Quack), and lights and light housings installed along a driveway (see U.S. Pat. No. 5,683,170 to Blaha). Lights and light housings have also been developed to provide even distribution upon the ground (see U.S. Pat. No. 3,836,767 to Lasker).

Various methods of mounting exterior lighting have been developed, including embedding a base supporting the housing in concrete (see U.S. Pat. No. 3,364,635 to Guggemos), bolting the support base to a concrete surface (see e.g. U.S. Pat. No. 4,519,657 to Jensen), and direct burial in soil (see U.S. Pat. No. 4,774,648 to Kakuk et al.).

Exterior lighting fixtures have been typically complex, difficult to install, and vulnerable to damage from vandals (see, for example, U.S. Pat. No. 3,257,496 to Hamilton). Exposed glass globes and light bulbs have been particularly susceptible to breakage and spray painting with graffiti.

The prior art does not show a fixture wherein the body of the fixture provides both a housing for the light and the structure for mounting to the environment without an intermediary support element. Typically, the light source is mounted to a base, which in turn, is covered with a housing, with or without one or more reflectors, to direct light through the glass or plastic globes or lenses within or comprising the housing. Traditionally, the base of the light housing is attached to a pole or other intermediary support element that is not truly part of the structure (see, for example U.S. Pat. No. 3,836,767 to Lasker, U.S. Pat. No. 3,257,496 to Hamilton or U.S. Pat. No. 1,794,467 to Lucas.) These intermediary attachment points between the light housing and the support are typically points of weakness, susceptible to loosening through the wear and tear of vibration, wind force, bending, breaking, corrosion, degradation of weather tight seals, and overall complexity of assembly.

Parts such as globes, reflectors, bases, and support posts have been typically custom, and replacements have typically had to come from the original manufacturer in order to maintain the original appearance of the lighting fixture. Thus, if the original manufacturer went out of business or changed product lines, the damage to but a few lighting fixtures on a property often mandates the necessity of replacing all of the lighting fixtures in order to maintain a uniform appearance. In addition, most lighting fixtures were equipped with a unique surface finish provided by the manufacturer. Thus, it was not possible to simply paint over graffiti, like a property owner might do with the surface of a building. Rather, the owner often had to either clean off the graffiti or replace the light fixture.

### OBJECTS OF THE INVENTION

A primary object and feature of the present invention is to fulfill the above mentioned needs by the provision of an improved system for lighting the environment of a property having electrical service, particularly property surrounding buildings. Specifically, an object and feature of the invention is to provide a system for efficiently lighting the exterior of buildings wherein the system can be fabricated from commonly available materials so that the original cost of manufacture is minimized and customized designs are feasible and inexpensive. Another object and feature of the invention, using commonly available materials, is that replacement parts for the system can be easily fabricated without necessarily relying on the original manufacturer. Another object and feature of the present invention is that the materials of manufacture be of a type commonly used in building construction so that personnel skilled in the maintenance of buildings will be readily able to maintain and repair the exterior lighting system without the investment involved in learning new skills.

Still another object and feature of the present invention is that it be easy to install, even directly in soil, and that installation require minimal additional parts and conditions. Other objects and features of the present invention include that it resist environmental degradation, including corrosion and ultraviolet damage, that, if desired, it match the texture and color of surrounding buildings, and that it be safe to use with electricity, preferably being substantially non-conductive. Further objects and features of the present invention include that it be strong, sturdy, resist damage from vandalism, and be easily repairable when damaged, including covering or removing graffiti. Even further objects and features of the present invention include that it be easy to maintain, including the replacement of light bulbs and other electrical components. A still further object and feature of the present invention is that it be aesthetically appealing and that variations matching in appearance be able to be installed in various places on a property environment, including in soil, on poles, on the side of buildings, along driveways, and on walls. Still even further objects and features of the invention are that it be inexpensive, easy to manufacture, convenient to ship, and easy to assemble.

The present invention provides fixed stable support directly to the environment without need for mounting plates, or anchor bolts, etc. Objects and features of this method of construction and design permit embodiments of the present invention to be mounted directly to the ground without intervening poles, pipes, brackets, or other means of support. Even further objects and features of the present invention provide that the light emitting windows in the fixture are easily customizable and do not substantially weaken the structure, as is experienced with a separate light enclosure attachment. Still a further object and feature of the present invention is the use of a one-piece replaceable lens that, by expansion tension between the lens and inner wall of the cylinder fixture, provides weatherproofing for the internal fixture components. A further object and feature of this one-piece lens is the ease with which it may be replaced should it be damaged or changed for aesthetic desires, such as holiday and event lighting color changes, or the inclusion of guidance text, such as the word “EXIT”.

Another object and feature of the present invention is to provide a method of manufacturing an article comprised of a stucco-coated circular cylinder. Objects and features of this method include that it provide a strong bond that is resistant to environmental degradation, including extreme temperature changes, and wherein the coated cylinder can be cut into complex geometries without disturbing the bond. Other objects and features of the method include that it be inexpensive, and that it provide a pleasing appearance. Other objects and features of the invention will become apparent with reference to the following invention descriptions.

### SUMMARY OF THE INVENTION

In accordance with a preferred embodiment hereof, this invention provides an exterior lighting system, for use in an environment having electrical service wiring, comprising in combination: at least one internal electric lamp, structured and arranged to receive at least one light bulb, and having electrical connections for the electrical service wiring; a substantially hollow enclosure, structured and arranged to house such at least one electric lamp and such electrical connections; wherein such substantially hollow enclosure comprises, a cylindrical peripheral wall, having an upper end and a lower end, at least one end cap mounted on such upper end, wherein such lower end of such cylindrical peripheral wall extends below ground thereby assisting in stably mounting such substantially hollow enclosure directly to the environment. Moreover, it provides such a exterior lighting system wherein such lower end is structured and arranged for mounting to the environment without use of any anchor bolts. Additionally, it provides such a exterior lighting system further comprising at least one attacher structured and arranged to attach such at least one internal electric lamp to such substantially hollow enclosure. Also, it provides such a exterior lighting system wherein a substantial portion of such peripheral wall is circular. In addition, it provides such a exterior lighting system further comprising, at least one mount structured and arranged to mount such at least one internal electric lamp; wherein such at least one mount extends below ground; and wherein such at least one mount does not contact such substantially hollow enclosure above ground. And, it provides such a exterior lighting system wherein such at least one mount is substantially isolated from such substantially hollow enclosure by the ground. Further, it provides such a exterior lighting system wherein a substantial portion of such cylindrical peripheral wall comprises a material selected from the group consisting of stucco, brick, stone, tile, and wood. Even further, it provides such a exterior lighting system wherein such at least one end cap is structured and arranged to provide access to such at least one internal electric lamp. Moreover, it provides such a exterior lighting system wherein such lower end further comprises a coupler structured and arranged to allow removal of a substantial above ground portion of such substantially hollow enclosure without removal of a below ground portion of such substantially hollow enclosure. Additionally, it provides such a exterior lighting system wherein such at least one end cap is structured and arranged as a rounded sphere, bowl, handle, dispenser, or adornment. Also, it provides such a exterior lighting system wherein such substantially hollow enclosure comprises at least one fencing attachment. In addition, it provides such an exterior lighting system wherein such at least one end cap comprises at least one fencing attachment. And, it provides such a exterior lighting system wherein such electrical connections are structured and arranged to include a coil of electrical wire structured and arranged to fit concentrically within such unitary substantially hollow right cylinder enclosure and allowing the removal of such at least one internal electric lamp without disconnection from the electrical service wiring. Further, it provides such a exterior lighting system wherein such cylindrical peripheral wall comprises at least two rows of windows structured and arranged to let light out of such substantially hollow enclosure. Even further, it provides such a exterior lighting system wherein: such substantially hollow enclosure comprises a circular cylinder, such end cap comprises a lens, with a lens axis perpendicular to a face of such lens, such end cap is mounted at an angle between such lens axis and a central axis of such circular cylinder, and wherein such angle is between 30 and 75 degrees.

In accordance with another preferred embodiment hereof, this invention provides an exterior lighting system, for use in an environment having electrical service wiring, comprising in combination: at least one internal electric lamp, structured and arranged to receive at least one light bulb, and having electrical connections for the electrical service wiring; a substantially hollow enclosure, structured and arranged to house such at least one electric lamp and such electrical connections; wherein such substantially hollow enclosure comprises a cylindrical peripheral wall; at least one window lens structured and arranged to let light out of such substantially hollow enclosure; and at least one attacher structured and arranged to attach such at least one internal electric lamp to such substantially hollow enclosure. Even further, it provides such a exterior lighting system wherein such at least one attacher is further structured and arranged to hold such at least one window lens against an interior surface of such substantially hollow enclosure. Even further, it provides such a exterior lighting system further comprising: at least one end cap mounted on a first end of such cylindrical peripheral wall; wherein such at least one attacher comprises at least one bracket, having a first bracket end and a second bracket end; wherein such first bracket end of such bracket is attached to such end cap, such second bracket end of such bracket is attached to such electric lamp, and wherein such end cap, such bracket, and such lamp are structured and arranged to be detachably removed as a unit.

In accordance with another preferred embodiment hereof, this invention provides an exterior lighting system, for use in an environment having electrical service wiring, comprising in combination: at least one internal electric lamp, structured and arranged to receive at least one light bulb, and having electrical connections for the electrical service wiring; a substantially hollow enclosure, structured and arranged to house such at least one electric lamp and such electrical connections; wherein such substantially hollow enclosure comprises a half-circular cylindrical peripheral wall.

In accordance with another preferred embodiment hereof, this invention provides an exterior lighting system, for use in an environment having electrical service wiring, comprising in combination: at least one internal electric lamp, structured and arranged to receive at least one light bulb, and having electrical connections for the electrical service wiring; a substantially hollow enclosure, structured and arranged to house such at least one electric lamp and such electrical connections; wherein such substantially hollow enclosure comprises, plastic pipe, and stucco.

In accordance with another preferred embodiment hereof, this invention provides a method of manufacturing an exterior lighting system article comprised of a substantially hollow cylinder, having a peripheral wall, comprising in combination the steps of: roughening the external peripheral wall of such substantially hollow cylinder; applying stucco to such external roughened peripheral wall; and allowing such stucco to cure. Even further, it provides such a method wherein the attachment structure for at least one internal electric lamp is installed within such substantially hollow cylinder prior to coating with such stucco.

### BRIEF DESCRIPTION OF THE DRAWINGS

FIG. 1 is a perspective view illustrating five different preferred embodiments of the exterior lighting system installed, and lighting the property next to a building.

FIG. 2 is a perspective view of a preferred column light installed in a lawn.

FIG. 3 is an exploded perspective view illustrating the top portion of a preferred column light detailing the electric lamp, light fixture hanger, lens, end cap, and electrical wire coil.

FIG. 4 is a detailed partial side sectional view of the peripheral wall of the preferred embodiment of the exterior lighting system showing an embedded sidewall attachment screw.

FIG. 5 is a perspective cut-away of the preferred light fixture column light showing the assembled electric lamp, lens, end cap and wire coil.

FIG. 6 is an exploded perspective view illustrating a preferred column light and showing the electric lamp, top end, hanger, and lens.

FIG. 7 is a sectional top view of the window portion of a column light illustrating how the lamp is preferably installed in the cylinder.

FIG. 8 is a side view, partially in section, of the column light installed in the ground and illustrating how the various components of the column light fit together and how the light is attached to the electrical service wiring.

FIG. 9 is a sectional top view of the window portion of the preferred embodiment of the column light of FIG. 8, illustrating how the electric lamp and lens are installed in the housing cylinder.

FIG. 10 is a side view, partially in section, of the column light illustrating how the various components of the preferred column light fit together and how the column light is structured and installed and connected to the electrical service wiring.

FIG. 11 is an exploded partial perspective view of the top portion of the preferred column light showing how the electric lamp and top end are structured and installed.

FIG. 12 is a perspective view illustrating a preferred embodiment of the exterior lighting system in viga light form installed and lighting the property.

FIG. 13 is a perspective view of a single preferred embodiment of the viga light.

FIG. 14 is a side view of a viga light, as attached to an exterior wall.

FIG. 15 is an underside view of the viga light of FIG. 14.

FIG. 16 is a sectional view of the viga light attached to an exterior wall and illustrating how the various components of the viga light fit together, and how the light is attached to the electrical service wiring.

FIG. 17 is a sectional top view of the window portion of the preferred embodiment of the column light of FIG. 16, illustrating how the electric lamp and lens are installed in the housing cylinder.

FIG. 18 is a partial perspective view of the preferred embodiment of the exterior of the fixture lighting system showing how the exterior surface is prepared for coating by sanding.

FIG. 19 is a partial perspective view of the preferred embodiment of FIG. 18 showing how the cylindrical body is cut to create light emitting windows prior to applying the exterior covering.

FIG. 20 is a partial perspective view of the preferred embodiment of FIG. 18 showing how the cylindrical body is inspected after coating and trimmed, if necessary.

FIG. 21 is a partial perspective view of a preferred embodiment of the exterior lighting system showing how screening is structured and installed prior to applying stucco.

FIG. 22 is a partial perspective view of the preferred embodiment of FIG. 21 of the exterior lighting system showing how stucco is structured and applied.

FIG. 23 is a partial perspective view of the preferred embodiment of FIGS. 21 and 22 of the exterior lighting system showing how the stucco-coated pipe may be cut to a desired geometry after the stucco is applied.

FIG. 24 is a perspective view of the pole light embodiment of the exterior lighting system showing how several embodiments of the present invention can be installed directly in soil.

FIG. 25 is an exploded partial perspective view of a pole light illustrating the lens and how the two lamps can be hung from the top end.

FIG. 26 is a partial perspective view of the wall top embodiment of the exterior lighting system.

FIG. 27 is an exploded partial perspective view, partially in section, of the wall top embodiment of the exterior lighting system showing how the wall top embodiment is installed.

FIG. 28 is a partial side sectional view of the wall top embodiment of the exterior lighting system showing how the wall top embodiment is installed.

FIG. 29 is an exploded partial perspective view of the vertical wall mount embodiment of the exterior lighting system.

FIG. 30 is a sectional side view of the vertical wall mount embodiment of the exterior lighting system showing how the vertical wall mount light is installed on the surface of a wall.

FIG. 31 is a sectional top view of the vertical wall mount embodiment of the exterior lighting system showing how the vertical wall mount light is installed on the surface of a wall.

FIG. 32 is a front view of the horizontal wall mount embodiment of the exterior lighting system.

FIG. 33 is a sectional side view of the horizontal wall mount embodiment of the exterior lighting system showing how the horizontal wall mount light is installed on the surface of a wall.

FIG. 34 is a perspective view of the flood light embodiment of the exterior lighting system.

FIG. 35 is a sectional side view of the flood light embodiment of the exterior lighting system showing how the lamp and reflector pivot, and how the lens is installed.

FIG. 36 is an exploded perspective view of the flood light embodiment of the exterior lighting system showing how the lamp and reflector are installed.

FIG. 37 is a partial perspective view of an embodiment of the exterior lighting system showing a brick coating.

FIG. 38 is a partial perspective view of an embodiment of the exterior lighting system showing a metal sheet coating.

FIG. 39 is a perspective view of the redwood embodiment of the exterior lighting system showing how it is installed.

FIG. 40 is a sectional top view of the redwood embodiment of the exterior lighting system showing how it is constructed, and how the lenses and lamp are installed.

FIG. 41 is a perspective view of the diffuse column light.

FIG. 42 is a side view of the diffuse column light.

FIG. 43 is a side view, partially in section, cut away of the diffuse column light installed in the ground and illustrating how the various components of the diffuse column light fit together and how the light is attached to the electrical service wiring.

FIG. 44 is a sectional top view of the internal light mounting portion of the preferred embodiment of the diffuse column light of FIG. 41.

FIG. 45 is a sectional bottom view of the light of the preferred embodiment of the diffuse column light of FIG. 41.

FIG. 46 is a partial side view of the below-ground portion of the column light illustrating the use and location of a coupling.

FIG. 47 is a side view, partially in section, cut away of a preferred embodiment of the column light installed in the ground and illustrating how the mount for the light is isolated from the enclosure.

FIG. 48 is top view section of the column light of FIG. 47.

FIG. 49 illustrating how column lights can be used as fence posts.

FIG. 50 is a perspective view of an embodiment of the exterior lighting system showing an attachment on the end cap for a fence chain or cable.

FIG. 51 is a perspective view of an embodiment of the exterior lighting system showing an attachment on the cylindrical wall for a fence chain or cable.

### DETAILED DESCRIPTION OF A PREFERRED EMBODIMENT AND THE BEST MODE OF PRACTICE

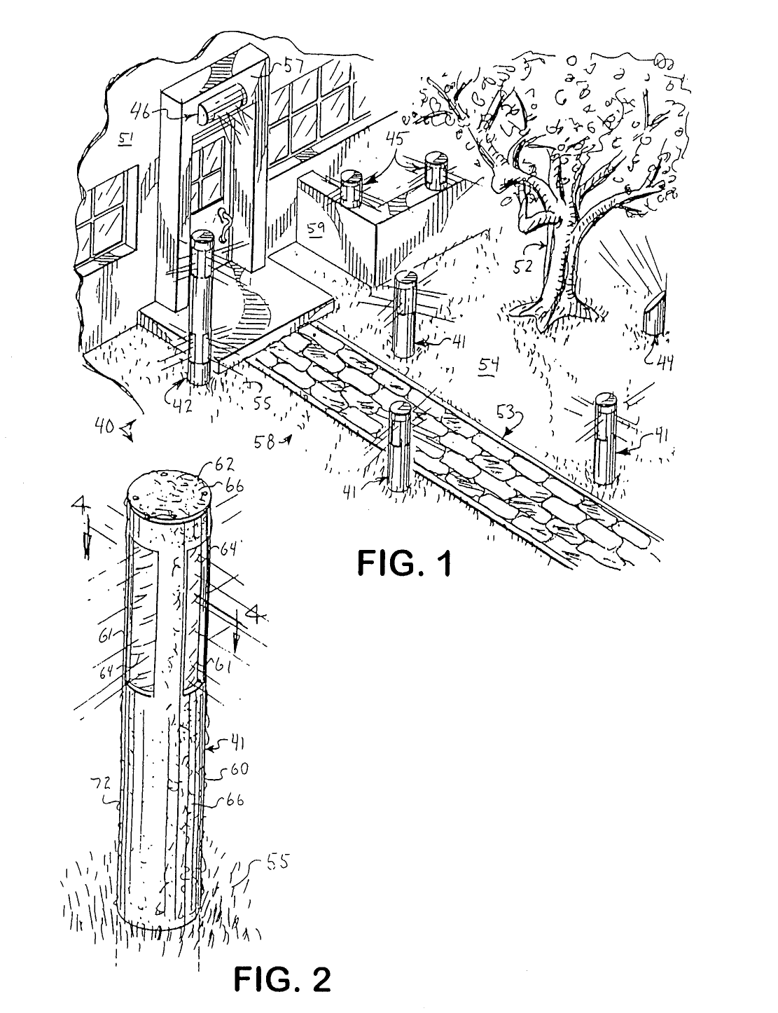

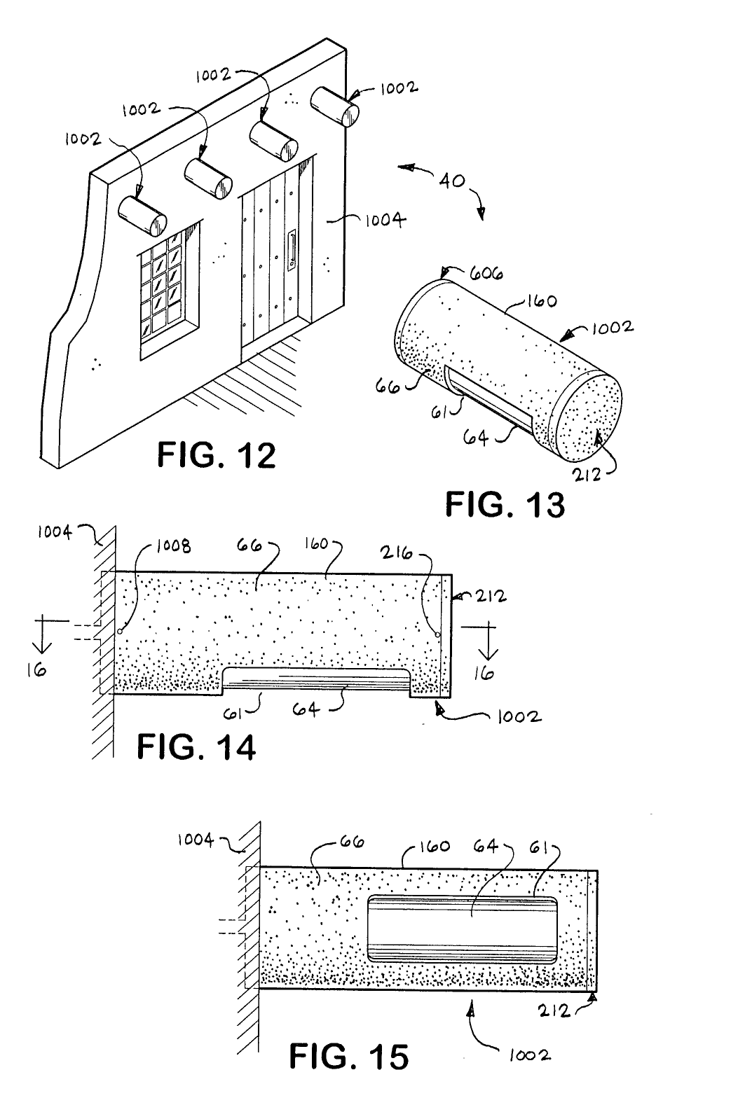

FIG. 1 is a perspective view illustrating five different preferred embodiments of the exterior lighting system 40 installed, typically, for lighting the property 58 next to a building 51. The embodiments of the exterior lighting system 40 that are shown are column light 41, pole light 42, flood light 44, wall top light 45, and horizontal wall mount light 46. An additional embodiment of the exterior lighting system 40 in a viga configuration is shown in FIG. 12. In each configuration shown, the exterior lighting system fixture is comprised of a substantially hollow right cylinder enclosure, having a peripheral wall, at least a substantial portion of said wall being circular, the enclosure having an exterior and interior surface, and being structured and arranged to house at least one electric lamp and the associated electrical connections.

The right cylinder incorporated in the preferred embodiment is of the type as defined by the Random House Dictionary on the English Language, “[a] cylinder is a surface or solid bounded by two parallel planes and generated by a straight line moving parallel to the given planes and tracing a curve bounded by the planes and lying in a plane perpendicular or oblique to the given planes.” (published 1969). It is the perpendicular nature of the cylinder in the present invention to which the title “right” is applied. Such a cylinder is not necessarily round.

As used herein, the terms environment and property, in the sense anticipated for the present invention, are to be recognized to encompass ground, buildings, walls, fences, and all other structures or features that might naturally be encountered in the natural or constructed environment in which the exterior lighting system 40 of the present invention is desired.

The column light 41 and pole light 42 are suitable for general illumination of any property 58, particularly that property 58 surrounding a building 51. Column light 41 is shown in a typical application, illuminating a walkway 53, and pole light 42 is shown in another typical application, illuminating a door to a building 51. Flood light 44 is typically used to shine light on particular above-ground-level 54 objects, such as a tree 52 (as shown), or the exterior of a building 51. Wall top light 45 is typically mounted on a wall 59 and is used to illuminate the property 58 near a wall 59. As shown, wall 59 is short, and is located next to building 51; however, wall top light could also be used on a higher wall 59, and could be used far from a building 51. Horizontal wall mount light 46 is shown mounted on the exterior wall surface 57 of a building 51, and illuminates the property 58 next to the building 51.

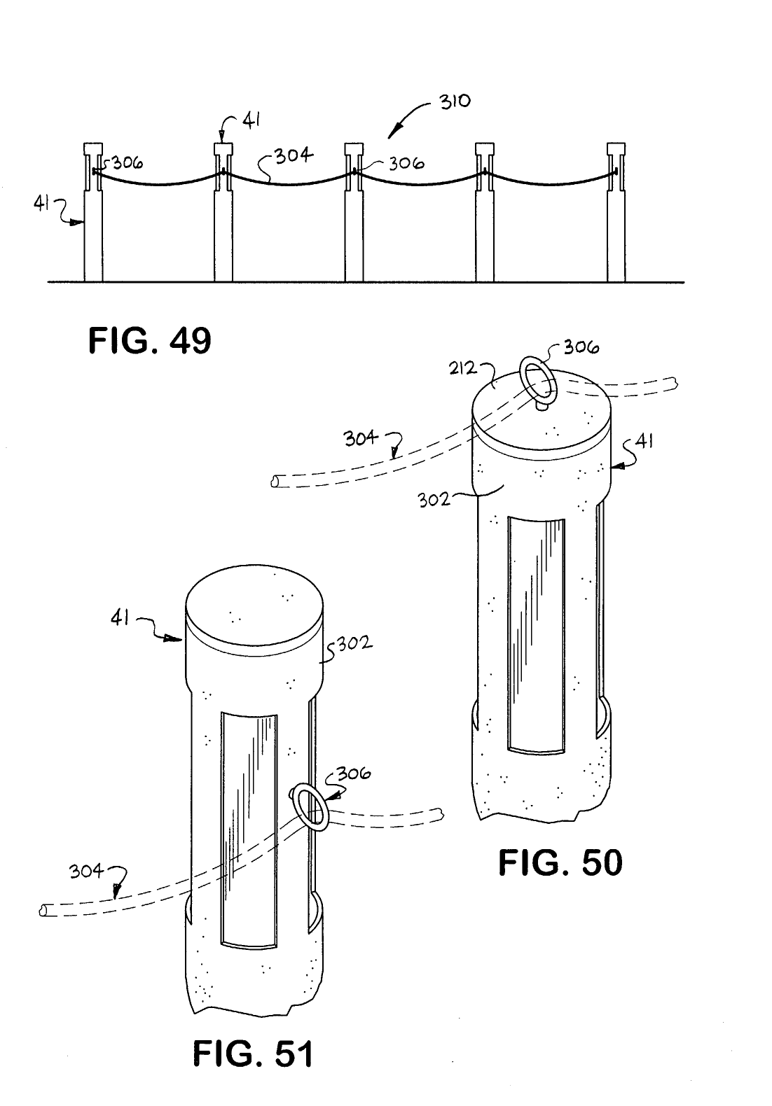

FIG. 2 is a perspective view of a column light 41 installed in a lawn 55. The column light 41 preferably has four peripherally-spaced elongated rectangular windows 61 (two shown) in the cylindrical body 60. Preferably, windows 61 are located just below such top end of such cylinder. The visible electromagnetic radiation (light) that column light 41 emits escapes through the windows 61. The top end 62 is shown coated with a preferred coating material, stucco 66. Top end 62 embodies herein at least one end cap mounted on such upper end. Under appropriate circumstances, it may be desirable to replace the substantially flat end cap with a more stylized or functionally adapted cap, such as a rounded sphere, bowl, handle, ornamentation, dispenser, or some other adornment. End cap may also include an attachment means for a cable, or chain, etc. so that the column light may serve as a fence post (See FIG. 49).

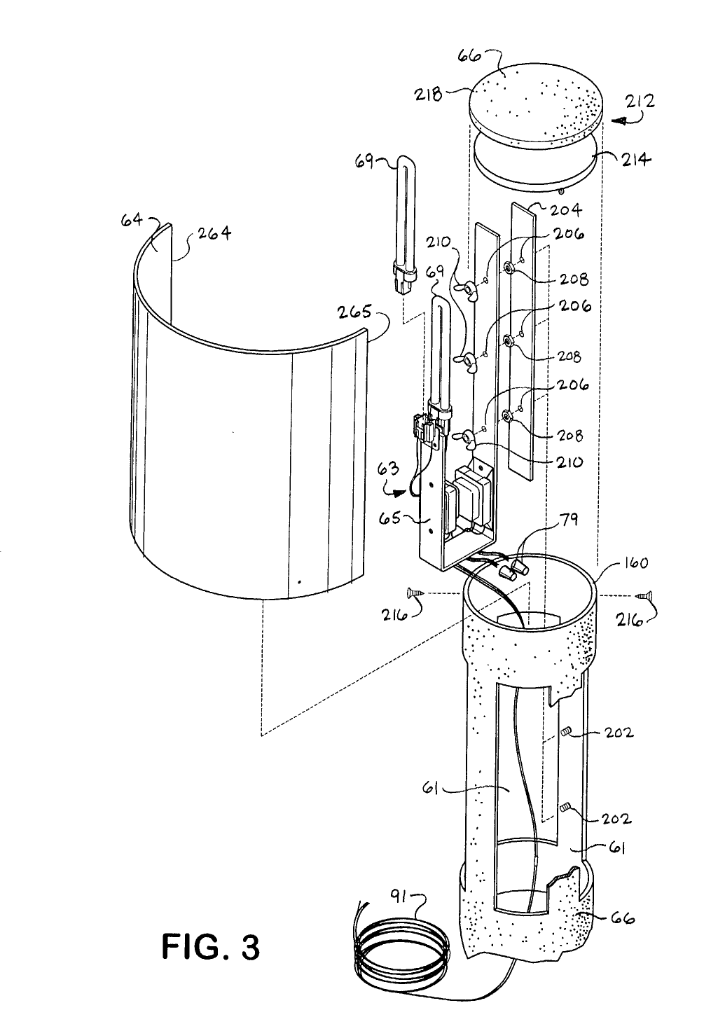

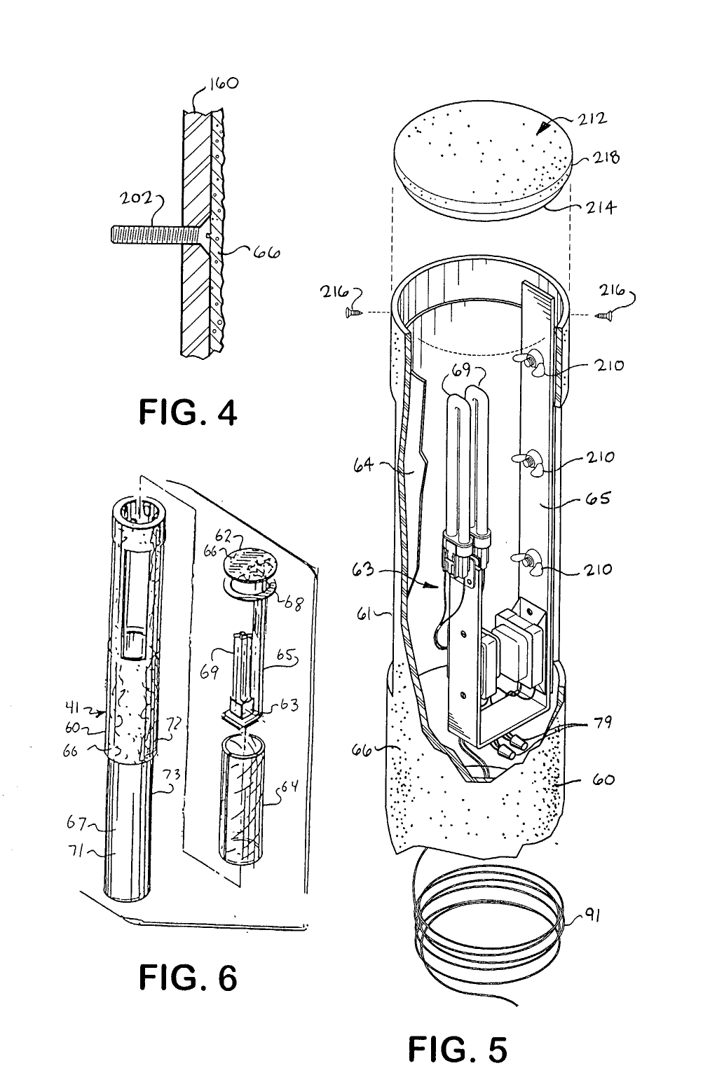

FIG. 3 is an exploded perspective view of the top most portion of the column light 41 and showing the primary components of the cylindrical body 60, electric lamp 63, the light fixture hanger 65, light fixture hanger attachment screws 202, the lens 64, and end cap 212. Electric lamp 63 is preferably of the type designed for outdoor use, and to preferably operate on 110-volt 60-cycle alternating current, as is predominantly available in the United States of America. Under appropriate circumstances, low voltage DC current electric lamps may be used. Further, in still other less preferred but appropriate circumstances, it may be desired to use a solar-powered or battery-powered electric lamp. Preferably, for consistency of lighting performance, fixed wire 110-volt or low voltage DC current electric lamps will most commonly be used. To provide the greatest amount of visible light for the amount of electricity consumed (greatest efficiency), electric lamp 63 is preferably of the fluorescent type, and is fitted with an appropriate number of suitable light bulbs 69. As shown in FIG. 4, the light fixture hanger attachment is preferably comprised of screws 202, preferably embedded in the sidewall of the cylindrical body 60 such that the threads of the screws 202 protrude from the interior sidewall of the cylindrical body with sufficient clearance to accommodate the lens retention plate 204, nuts 208, and light fixture hanger 65, as described in further detail below. The exterior portion of the screws 202 are covered with the exterior covering, such as stucco 66, so as to be hidden from view. Preferably, light fixture hanger 65 is a bracket. The use of screws 202 is preferred for the ease of use and strength in attaching the internal components, however, under appropriate circumstances, other less preferred attachment means may be substituted. As shown in FIG. 6, the location of attachment of the light fixture hanger 65 may be to the underside of the top end cap 62. Moreover, the preferred attachment means for attaching the internal electric lamp is preferably attached to the peripheral wall of the enclosure means, however, under appropriate circumstances, the attachment means for attaching the internal electric lamp may be attached to the underside of the end cap, the end cap provides access, for it may be unfastened from the enclosure, thus providing access to the interior of the enclosure.

The lens 64 is preferably a polycarbonate sheet of a thickness conductive to bending, and is preferably substantially transparent. The lens 64 is rolled so as to bring side ends 264 and 265 nearly together. In so doing, the lens 64 is formed into an incomplete cylinder of a diameter smaller than the inside diameter of the cylindrical body 60 comprising the lighting system 40. The lens is preferably placed within the clean cylindrical body 60 in such a fashion as to cover the light emitting windows openings 61, and aligned such that the gap between lens edges 264 and 265 is aligned to accommodate the light fixture hanger attachment screws 202 protruding from the interior of the cylindrical body 60. The natural tendency of the lens 64 to unroll and provide positive pressure against the internal sidewall of the cylindrical body 60 achieves a system wherein the single piece of light transmitting flexible material positioned internally within the enclosure and covering at least one of the at least one window openings, weatherproofs the at least one window.

Preferably, a lens retention plate 204, with corresponding holes 206 for the light fixture hanger attachment screws 202, is affixed over the attachment screws 202, preferably with nuts 208 to further securely press and hold the lens 64 in place. Preferably, light fixture hanger 65 and lens retention plate 204 are combined to be more efficient and economical than separate attachments. The light fixture hanger 65 is preferably structured and arranged with corresponding holes 206 for the light fixture hanger attachment screws 202. This arrangement of the lens 64, attachment screws 202 and lens retention plate 204, and other internal components, is best shown in FIG. 9 (embodying herein wherein such at least one attacher is further structured and arranged to hold such at least one window lens against an interior surface of such substantially hollow enclosure).

Attachment of the light fixture hanger 65 is preferably completed with the use of wing-nuts 210, so that attachment and removal of the light fixture hanger 65 can be achieved by the hand of the repair technician without the need of wrenches or other special tools. Connection of the electric lamp 63 to the coil of electrical wire 91 is preferably achieved by means of wire nuts 79. The coil of electrical wire 91 is preferably connected to the electrical service wiring (not shown). To complete closure of the fixture column light 41 and protect the internal electric lamp 63 and electrical wiring and coil of electrical wire 91, an end cap 212 is attached to the top of the fixture column light 41. The end cap 212 is comprised of two planer disks, a top exterior disk 218 that is the same diameter as the exterior of the cylindrical body 60, and an interior plug disk 214 with a diameter approximate to the interior diameter of the cylindrical body so as to achieve a snug fit. Preferably, the exterior disk 218 is coated with the same outer covering material, such as stucco 66, that has been applied to the exterior of the fixture column light 41. The interior plug disk 214 is centered and attached to the underside of the exterior disk 218 such that the assembled end cap 212 preferably fits snugly and flushly atop the cylindrical body 60. When assembled, preferably the end cap 212 is approximately ½ inch thick. The end cap is preferably held in place by screws 216 which extend through the sidewalls of the cylindrical body 60 and into the interior plug disk 214 of the end cap 212 (wherein such at least one end cap is structured and arranged to provide access to such at least one internal electric lamp).

FIG. 5 is a cut-away of the fixture column light 41 showing the lens 64 positioned to cover the window openings 61, light fixture hanger 65 with the electric lamp 63 and light bulbs 69 attached to the sidewall of the cylindrical body 60 by the hanger attachment screws 202 and wing-nuts 208, the coil of electrical wire 91 connected to the electric lamp 63 by wire nuts 79 (the electrical connections are preferably structured and arranged to include the coil of electrical wire 91, permitting the removal of the electric lamp 63 and light fixture hanger 65 without disconnect or removal of the fixture column light 41), and the assembled end cap 212 to be held in place by screws 216. Under appropriate circumstances, at least one end cap may be structured and arranged as a rounded sphere, bowl, handle, dispenser, or adornment.

FIG. 6 is an exploded perspective view illustrating a variation in the embodiment of the column light 41 and showing the electric lamp 63, top end 62, light fixture hanger 65, and lens 64. As shown in this configuration, electric lamp 63 is preferably attached to light fixture hanger 65, which is preferably attached to top end 62. Thus, in the preferred embodiment of column light 41, top end 62, light fixture hanger 65, and electric lamp 63 can be removed as a unit to access electric lamp 63, such as to replace light bulbs 69 (embodying herein at least one end cap mounted on a first end of such cylindrical peripheral wall, wherein such at least one attacher comprises at least one bracket, having a first bracket end and a second bracket end, wherein such first bracket end of such bracket is attached to such end cap, such second bracket end of such bracket is attached to such electric lamp, and wherein such end cap, such bracket, and such lamp are structured and arranged to be detachably removed as a unit). As shown, preferably the electric lamp 63 embodied herein is a fluorescent-type lamp structured and arranged to receive at least one fluorescent-type light bulb that is essentially the same length as such long side of such windows, and wherein such exterior lighting system is structured and arranged so that when the light bulb is installed, it will be located adjacent to and parallel with such long sides of such windows. As described above, the lens 64 is preferably one piece of substantially transparent material that has been rolled into an incomplete cylinder of slightly less than 360° as shown, and mounted to cover (from the inside) all of windows 61. Lens 64 can be easily removed (if needed) from the cylindrical body 60 once top end 62 is removed. Column light 41 (and the bodies of several of the other within embodiments) is preferably constructed from plastic pipe, preferably polyvinyl chloride (PVC) pipe 71 of the type widely available for domestic and commercial use. PVC pipe 71 is preferably type PSM PVC gravity sewer pipe meeting ASTM standard D 3034, and having a tensile strength of 6000 psi under ASTM test D 638. PVC pipe 71 used with column light 41 is preferably of 6-inch nominal diameter, with an actual outside diameter of 6.275-inches and a minimum wall thickness of 0.241-inches. As will be described in more detail below, column light 41 is preferably constructed to be installed with a portion of the cylindrical body 60 embedded in the ground 54 (below grade). The below-ground portion 73 of the cylindrical body 60 of column light 41 is preferably not coated, while the above-ground portion of column light 41 is preferably coated, and is shown in FIG. 6 coated with stucco 66 (embodying herein wherein such lower end of such cylindrical peripheral wall extends below ground thereby assisting in stably mounting such substantially hollow enclosure directly to the environment and further embodying herein wherein such lower end is structured and arranged for mounting to the environment without use of any anchor bolts).

The below-ground portion 73 of column light 41 is preferably about 18 inches long. In a preferred embodiment of the preset invention, the below-ground portion 73 of the column light 41 may further comprise a coupling 280 (see FIG. 46), preferably a slip coupling, preferably a PVC slip coupling, permitting temporary removal of the above-ground portion 72 without excavation. Preferably, the slip coupling is located entirely below-ground. The above-ground portion 72 of column light 41 can be many different sizes, all preferably equal to the standard widths of window screen 94 (see the description of FIG. 22 below). For typical installations, applicant's preferred length for the above-ground portion 72 of column light 41 is about 42 inches. Thus, a preferred overall length of PVC pipe 71 for column light 41 is 60 inches.

Column light 41 can also be made of smaller (preferably 3-inch nominal diameter) PVC pipe 71, preferably of similar proportion to the larger 6-inch diameter version described above. This smaller version of column light 41 is preferably equipped with low voltage lamp 63 (not shown) and used to illuminate a driveway (not shown) or walkway 53 (as depicted in FIG. 1). The length of the above-ground portion of this smaller, driveway version, of column light 41 is preferably 24 inches.

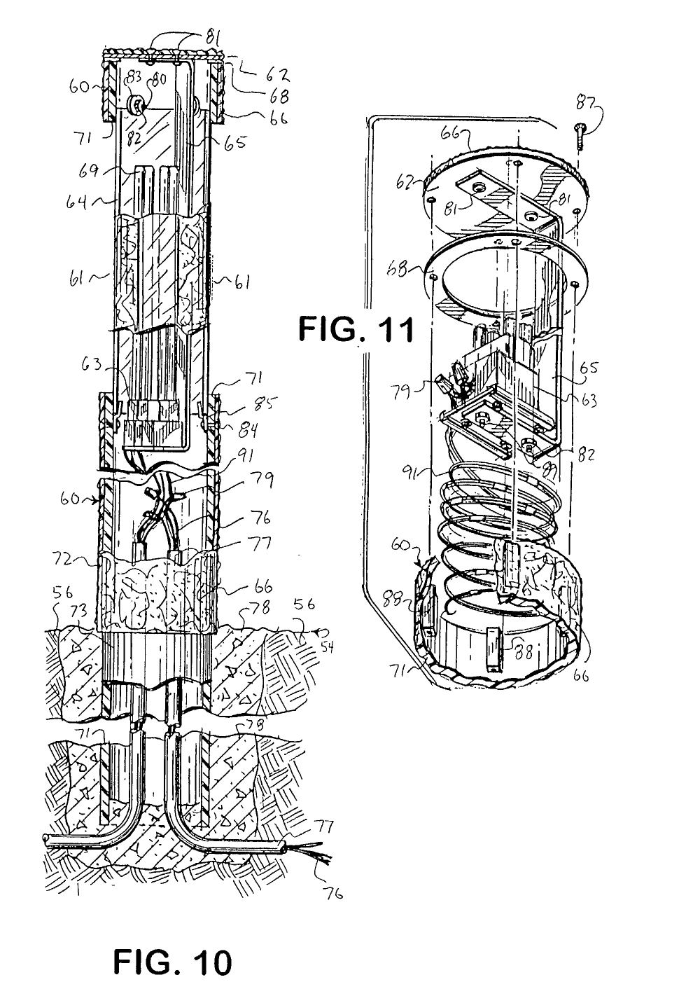

FIG. 8 and FIG. 10 are cut-away depictions showing a preferred method of installing column light 41 in the ground 54. As previously described, the lower portion of the enclosure, opposite to window opening 61, is structured and arranged for partial burial in the ground 54 to provide stable mounting with the axis of the enclosure substantially vertical. Thus, the below-ground portion 73 of the PVC pipe 71 forming the cylindrical body 60 of the column light 41 is preferably uncoated (i.e., no stucco 66). Electrical service wiring 76 is preferably installed, either in conduit 77 (preferably, as shown) or without conduit (direct burial—not shown). The column light 41 may be installed in the same trench (not shown) that is dug to install the electrical service wiring 76. If the electrical service wiring 76 is lower than the bottom of cylindrical body 60, then the electrical service wiring 76, and conduit 77, if provided, is preferably routed up through the bottom end of cylindrical body 60, as shown. If the electrical service wiring 76 is above the bottom of cylindrical body 60, then the bottom of cylindrical body 60 can be notched or drilled at the convenience of the installer using tools and methods well-known to a person of ordinary skill in the art. As noted above, in a preferred embodiment of the present invention, the below-ground portion 73 of the column light 41 may further comprise a slip coupling 280 (see FIG. 46), preferably a slip coupling, preferably a PVC slip coupling, permitting temporary removal of the above-ground portion 72 without excavation. Preferably coupling 280 is permanently attached to the lower section of the below-ground portion 73 of column light 41. Such temporary removal of the above-ground portion 72 of the column light 41 may be desired to provide direct access to the electrical service wiring 76, or replacement of the above-ground portion 72 of the light column 41 should it become damaged (embodying herein wherein such lower end further comprises a coupler structured and arranged to allow removal of a substantial above ground portion of such substantially hollow enclosure without removal of a below ground portion of such substantially hollow enclosure).

Preferably, when the below-ground coupling 280 is used as shown in FIG. 46, concrete is utilized to further support and stabilize the column light 41. To help deter theft of the column light 41 and provide greater structural rigidity, preferably the concrete 78 is not brought to grade level, rather there is sufficient clearance between the top of the concrete 78 pour and ground level 54 to enable the use of screws 282. Preferably, screws 282 extend through the sidewalls of the coupling 280 and into side walls of the cylindrical body 60. Preferably, soil 56, lawn grass (not shown) or other matching surface covering is used to cover screws 282.

The underground electrical service wiring 76 is preferably connected to the coil of electrical wire 91, which is connected to lamp 63, preferably with more wire nuts 79, should complete removal and replacement of the lamp 63 be necessary at some point. The coil of electrical wire 91 is preferably slightly smaller in diameter than the inside of the cylindrical body 60, and fits below lamp 63. The coil of electrical wire 91 preferably allows lamp 63 to be lifted out and reinstalled without disturbing the connections secured by wire nuts 79. The coil of electrical wire 91 also prevents the wiring from getting above lamp 63 and casting a shadow on lens 64.

As shown in FIG. 8, the electric lamp 63 and light bulbs 69 are affixed by the light fixture hanger 65 to the interior sidewall of the cylindrical body 60 by means of wing nuts 208, as applied to the light fixture attachment screws 202. Such attachment of the electric lamp 63 to the interior side of the cylindrical body 60 fixture permits ease of replacing bulbs 69, simply by removing the screws 216 securing the end cap 212, and does not require or entail removal of the electric lamp 63 fixture itself, unless desired by the servicing technician.

As shown in FIG. 8 and FIG. 10, the electrical connections between the electrical service wiring 76 and the lamp 63 are preferably structured and arranged to include a coil of electrical wire 91 structured and arranged to fit concentrically within the enclosure and permitting the removal of the internal electric lamp 63 without disconnection from the electrical service wiring 76 (embodying herein wherein such electrical connections are structured and arranged to include a coil of electrical wire structured and arranged to fit concentrically within such unitary substantially hollow right cylinder enclosure and allowing the removal of such at least one internal electric lamp without disconnection from the electrical service wiring). The below-ground portion 73 of cylindrical body 60 can be installed directly in-ground 54 (as shown in FIG. 24); however, it is preferable to place about 50 to 60 pounds of concrete 78 around the below-ground portion of cylindrical body 60, as shown in FIG. 8 and FIG. 10. Concrete 78 helps to stabilize the cylindrical body column light 41 to prevent it from being tipped out of plumb if someone pushes on it. This preferred arrangement with below-ground portion 73 embodies herein a mounting means for mounting the light fixture (comprised of a light housing and enclosure, elevation support and ground anchor in a structure) directly in soil. Although not shown, it is preferable that at least a portion of the bottom of cylindrical body 60 contact soil 56 so that any water that gets inside cylindrical body 60 can sink into the ground 54. The cylindrical fixture column light 41 should preferably be installed plumb and in a manner familiar to a person of ordinary skill in the art of installing poles and posts.

FIG. 9 is a sectional top view of the above-ground portion 72 of the cylindrical body 60 and light emitting windows 61 illustrating how the electric lamp 63 and light fixture hanger 65 is preferably structured and arranged to attach to the inner sidewall of the cylindrical body 60 by means of the preferred wing-nuts 210 tightened upon the attachment screws 202 embedded in the sidewall of the cylindrical body 60. As shown in this view, the preferred placement of the lens 64 is clearly evident as being flush with the interior wall of the cylindrical body 60. Additionally, the ends 264 and 265 of the lens 64 are shown as nesting approximate to the hanger attachment screws 202. Further, the preferred structure and arrangement of the lens retention plate 204 and nuts 208 as they function to press the lens 64 firmly against the internal surface of the cylindrical body 60 is depicted. As shown in FIG. 9, the preferred light bulbs 69 are free and clear of obstructions that would either diminish their transmission of light through the window openings 61, or inhibit the ease of access for removal and replacement by a user technician.

As shown, the light bulbs 69 are preferably located directly behind windows 61, thus permitting the greatest amount of light to emerge through the windows 61 (embodying herein a window means for allowing light from the at least one internal electric lamp to escape from the enclosure means). Light bulbs 69 can easily be replaced in column light 41 by removing screws 216 and lifting up top end cap 212, this arrangement embodying herein an access means for servicing the at least one internal electric lamp, replacing the light bulb or bulbs, and servicing the weatherproofing means.

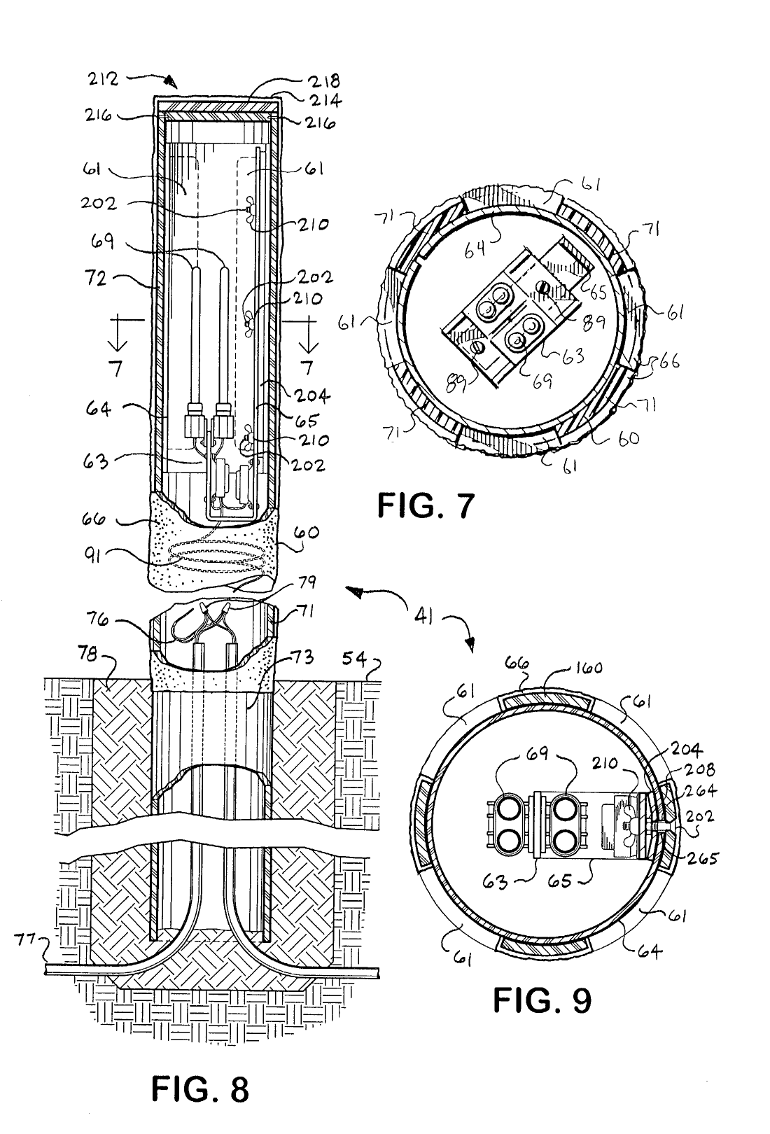

FIG. 7 is a sectional top view of the above-ground portion 72 of the alternative configuration of column light 41 (as shown in FIG. 6), through the windows 61, illustrating how the lamp 63 is installed in the body 60. FIG. 10 is a side view, partially in section, of the column light 41, illustrating how the various components of the column light 41 fit together and how the column light 41 is installed and connected to the electrical service wiring. FIG. 11 is an exploded partial perspective view of the top portion of the column light 41 showing how the electric lamp 63 and top end 62 are installed. As can be seen in these figures, in this alternative configuration, lamp 63 preferably attaches to hanger 65 with two screws 89 with nuts 82, as shown. Hanger 65 preferably attaches to top end 62 with two fasteners 81, as shown. Top end 62 (embodying herein an end piece structured and arranged to attach to such top end of such cylindrical body) is preferably a round piece of galvanized-steel sheet metal, preferably, about 1/16-inch thick, with a coating applied externally, such as stucco 66, as shown. Fasteners 81 are not typically disassembled for maintenance or other purposes, and so can be rivets. Screws, with or without nuts, would also work; however, rivets are preferred for fasteners 81. Top end 62 preferably attaches to cylindrical body 60 with four screws 87, which are preferably of a type suitable to attach to plastic. Screws 87 preferably attach to four blocks 88, which are plastic, preferably PVC, and are glued to PVC pipe 71 of cylindrical body 60 with a suitable adhesive readily selectable by a person of ordinary skill in the art of fabricating articles from plastic. Blocks 88 (best shown in FIG. 11) contain holes of a diameter suitable for screws 87. Gasket 68 fits between top end 62 and cylindrical body 60, and preferably has four holes for screws 87. Gasket 68 preferably keeps water and dust out of exterior lighting system 40, which could damage lamp 63 or the various electrical connections. Gasket 68 is preferably made of a soft rubber material, such as neoprene, that remains pliable for a long time.

When top end 62 is installed on the cylindrical body 60, light bulbs 69 are located directly behind windows 61, so that the greatest amount of light possible is emitted through the windows 61. When top end 62 is installed on the cylindrical body 60, hanger 65 is preferably located between two windows 61 (see FIGS. 7 and 8) so that hanger 65 does not cast a shadow on one of the windows 61. As described above and shown best in FIG. 7, one lens 64 preferably covers all four windows 61 on the inside of PVC pipe 71. Lens 64 forms an incomplete cylinder, and, as shown best in FIG. 7, lens 64 is preferably installed so that the gap is hidden between two windows 61. As shown best in FIG. 10 of this alternative configuration, lens 64 is preferably supported by four clips 85, which are secured in place (to the cylindrical body 60) by fasteners 84. Fasteners 84 are similar to fasteners 81 described above. Also, as shown best in FIG. 10, lens 64 is secured on the top to the cylindrical body 60 by four screws 80 with nuts 82 and fender washers 83. Clips 85 and fender washers 83 keep lens 64 from being pushed in when a force is applied on the exterior of lens 64. Light bulbs 69 can easily be replaced in column light 41 by removing screws 87 and lifting up top end 62, along with hanger 65 and lamp 63. Also, this arrangement with hanger 65 embodies herein a bracket having a top end and a bottom end, wherein such top end of such bracket is attached to such end piece, such bottom end of such bracket is attached to such electric lamp, and wherein such end piece, such bracket, and such lamp are structured and arranged to be raised through such cylinder as a unit. Lens 64 can easily be replaced by removing top end 62, as just described, removing nuts 82 and fender washers 83, compressing and lifting out the old lens 64, and rolling up and installing the new lens 64 into clips 85. Fender washers 83 and nuts 82 can then be re-installed.

As noted above in the discussion of FIG. 3, lens 64 is preferably a polycarbonate sheet of a thickness conducive to bending to the desired PVC pipe 71 diameter. Lens 64 must be translucent (able to pass light), but need not be transparent (able to see through). However, a transparent material will work, and may be most efficient at transmitting light. Lens 64 (embodying herein that such light-transmitting material comprises substantially a thin cylindrical body which fits within and is held by such hollow right cylinder) performs several functions, including protecting light bulbs 69 and lamp 63 from various forms of environmental damage, e.g., from the elements and from vandals. Lens 64 keeps water out from rain or sprinklers, and keeps dust out, particularly in dusty climates, such as in Phoenix, Ariz., and the surrounding areas. It is desirable to keep water out because it may short-out or otherwise damage lamp 63 or the electrical connections. Lens 64 may not exclude all water, but any water that does get in will harmlessly run down the inside of PVC pipe 71 to the ground 54. It is desirable to keep dust out, because it coats light bulbs 69 and the backside of lens 64, and reduces the transmission of light. Fasteners 81 and 84 are essentially permanent, and the stucco (or other coating as described below) is preferably either applied after fasteners 81 and 84 are installed, or the coating is repaired after fasteners 81 and 82 are installed. Similarly, the stucco can be repaired or applied over screws 80, and future lens 64 replacement can be accomplished by removing nuts 82, but not disturbing screws 80.

FIG. 12 is a perspective view of the preferred embodiment of the viga light 1002 of the exterior lighting system 40, installed as vigas typically are, in the upper portion of an exterior wall 1004 for aesthetic architectural design. Viga's are traditional components to southwestern design and construction. Specifically, a viga is a rafter or roof beam, especially a trimmed and peeled tree trunk, whose end projects from an outside adobe wall. With modern construction, artificial viga components appearing in natural wood or with a stucco finish are frequently added for aesthetic appeal.

FIG. 13 is a perspective view of a single preferred embodiment of the viga light 1002, depicting the light window 61, lens 64, cylindrical body 60, end cap 212, base cap 606, and the preferred exterior coating of stucco 66.

FIG. 14 is a side view of viga light 1002, further illustrating the end cap screw 216, base cap screw 608, and providing special orientation, as indicated by arrows for FIG. 15, an underside view of viga light 1002, as shown in FIG. 14, showing the light emitting window 61, lens 64, end cap 212 and base cap 606.

In both FIG. 14 and FIG. 15, the preferred mounting of the viga light 1002 so as to partially recess the base cap 606 within the exterior wall 1004, is shown. Although this depiction of embedded mounting is preferred, it is, of course, to be understood that under the appropriate circumstances, such as installing the viga lights 1002 to an existing house, the base cap 606, and indeed the viga light 1002 itself, may be flushly mounted to the exterior wall 1004.

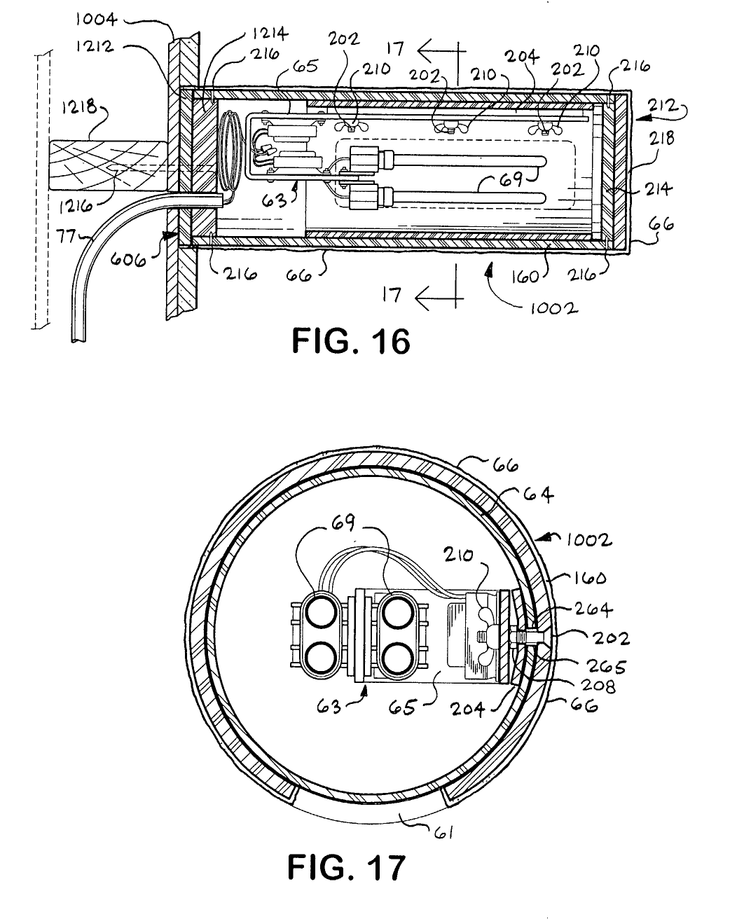

FIG. 16 is a cross-sectional view of the preferred embodiment of the viga light 1002 of the exterior lighting system 40, as indicated in FIG. 14. The electrical service wiring 76 is preferably installed in conduit 77, or without conduit (not shown), if permitted by local code, and preferably attached to the electric lamp 63 by wire nuts 79. Preferably, the wiring extending from the electric lamp 63 is sufficiently long enough to permit complete removal of the electric lamp 63 and the light fixture hanger 65 without requiring complete disconnection from the electrical service wiring or removal of the viga light 1002.

As illustrated, the light fixture hanger 65 is attached to the interior sidewall of the cylindrical body 60, comprising the housing for the viga light 1002, in a manner similar to that described for attachment of the light fixture hanger 65 with respect to the column light depicted in FIG. 8. The light fixture hanger 65 is structured and arranged to align with the attachment means established in the sidewall of the interior of the cylindrical body 60. As described above in this specification, the preferred method of attachment entails the use of attachment screws 202 embedded through the exterior of the cylindrical body 60 such that the threaded ends are exposed to the interior and available to accept the preferred wing-nuts 208 used to affix the light fixture hanger 65. Preferably, the exterior portion of the screws 202 are covered with the exterior coating, such as stucco 66, applied to the entire external surface of the cylindrical body 60. Attachment of the electric lamp 63 and the light fixture hanger 65 to the interior sidewall of the cylindrical body is preferable, as the alignment of the light bulbs 69 with the light-emitting window 61 is unobstructed.

The exterior end cap 212 is preferably comprised of two planer disks, an exterior disk 218 that is the same diameter as the exterior of the cylindrical body 60, and an interior plug disk 214, with a diameter approximate to the interior diameter of the cylindrical body 60, so as to achieve a snug fit. Preferably, the exterior disk 218 is coated with the same outer covering material, such as stucco 66, that has been applied to the exterior of the fixture column light 41. The interior plug disk 214 is centered and attached to the underside of the exterior disk 218 such that the assembled end cap 212 preferably fits snugly and flushly in the exposed end of the cylindrical body forming the viga light 1002. The exterior end cap 212 is preferably held in place in the cylindrical body 60 by screws 216.

The base cap 606 is likewise preferably comprised of two planer disks, an outer disk 1212 that is the same diameter as the exterior of the cylindrical body 60, and an interior plug disk 1214, with a diameter approximate to the interior diameter of the cylindrical body, so as to achieve a snug fit. To provide sufficient anchor support for the assembled viga light 1002, the interior plug disk is preferably 1 inch thick. The interior plug disk 1214 is centered and attached to the underside of the outer disk 1212. A hole of the proper size and orientation is drilled or otherwise created to permit the electric service wiring to pass through the interior end cap and enter the viga light 1002. Preferably, the base cap 606 is affixed to the exterior wall 1004 during the construction of the building. Such early placement permits greater ease in alignment with electrical service wiring (not shown) in conduit 77, as well as recessing the base of the viga light 1002 slightly into the finished surface of the exterior wall 1004, for what may be a more desired aesthetic appearance of actual protrusion from the exterior wall 1004. Affixture of the base cap 606 to the exterior wall 1004 is achieved by whatever means appropriate and selected by the installer, including, but not limited to bolting, nailing, screwing, and bonding. As indicated in FIG. 16, a nail 1216 has been used to attach the interior end cap to the exterior wall 1004, and preferably to an inner structural beam 1218.

FIG. 17 is a sectional end view of the viga light 1002 of the exterior lighting system 40. Illustrated here is the configuration of the cylindrical body 60 forming the housing and support for the electric lamp 63 and light fixture hanger 65, and is preferably structured and arranged to attach to the inner sidewall of the cylindrical body 60 by means of the preferred wing-nuts 210 tightened upon the attachment screws 202 embedded in the sidewall of the cylindrical body 60. As is shown in this view, the placement of the lens 64 is preferably flush with the interior wall of the cylindrical body 60. Additionally, the ends 264 and 265 of the lens 64 are shown as nesting approximate to the hanger attachment screws 202. Further, the preferred structure and arrangement of the lens retention plate 204 and nut 208 as they function to press the lens 64 firmly against the internal surface of the cylindrical body 60 is clearly depicted. As is shown in FIG. 17, the preferred light bulbs 69 are free and clear of obstructions that would either diminish their transmission of light through the window opening 61, or inhibit the ease of access for removal and replacement by a user technician. The viga light 1002 thus described is an embodiment of the exterior lighting system 40 wherein the enclosure further comprises two end caps, and is structured and arranged for mounting by one end cap to an essentially flat, essentially vertical surface, with the axis of the enclosure substantially horizontal and aligned substantially perpendicular to the vertical mounting surface.

Column light 41 can also be constructed from steel pipe (not illustrated), rather than PVC or other plastic pipe 71, and used as an anti-vehicle barrier, as well as a light. In such an application, to prevent column light 41 from being forced out of the ground by the impact of a vehicle, below-ground portion 73 would preferably be longer, and more concrete 78 would preferably be used. Although not illustrated herein, in such an application, it would also be advantageous to fill the cylindrical body 60 with concrete to just below the bottom of lamp 63 to prevent the bottom part of column light 41 from buckling when impacted by a vehicle. Column light 41 may have the same coating (for example, stucco 66), and therefore, the same appearance, if steel pipe were used, rather than PVC pipe 71.

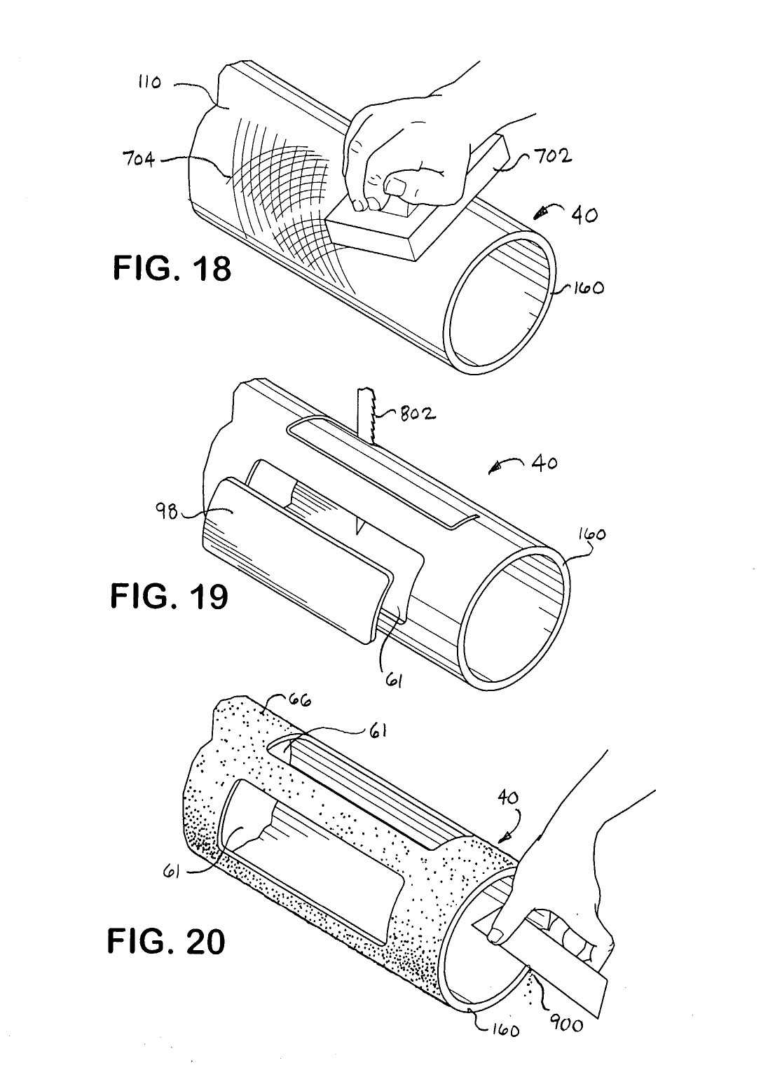

FIG. 18 through FIG. 20 depict the general steps of preferably preparing the exterior surface of a preferred embodiment of a cylindrical body 60 for the application of an exterior surface coating, such as stucco 66, the cutting of light-emitting windows 61, and such trimming 902, as may be required. As previously discussed, the cylindrical body 60 is preferably constructed from polyvinyl chloride (PVC) pipe of the type widely available for domestic and commercial use. The preferred PVC pipe is preferably type PSM PVC gravity sewer pipe meeting ASTM standard D 3034 and having a tensile strength of 6000 psi under ASTM test D 638. The pipe used with the construction of the cylindrical body is preferably of 6-inch nominal diameter, with an actual outside diameter of 6.275-inches, and a minimum wall thickness of 0.241-inches. Under appropriate circumstances, PVC pipe of a smaller or larger diameter may be used for the creation of exterior lighting system components, as may be desired. As taught under the present invention, the preferred column light fixture is circular in cross section, for such circular cross section configuration improves structural integrity, simplifies manufacturing and installation, etc . . . . Though a circular cross section is preferred, under appropriate circumstances, it may be desirable to produce a column light 41 that is oval or elliptical in cross-section. The application of heat and pressure along the longitudinal access of the cylindrical body 60 will easily produce such variations in shape, and such an alteration in cross-sectional appearance, while not a preferred embodiment, is understood not to affect most of the purposes or functions of the present invention.

FIG. 18 is a partial perspective view of a preferred embodiment of the exterior fixture lighting system 40 showing how the surface 110 of the PVC pipe cylindrical body 60 is preferably prepared by sanding 702 prior to applying stucco 66, or such other aesthetic surface covering, as may be desired. Sanding 702, preferably accomplished by hand or such other means as may be appropriate for volume production, imparts surface roughness 704 to the exterior surface 110 of the cylindrical body 60. This surface roughness 704 provides greater opportunity for the stucco 66 to bond securely to the exterior of the cylindrical body 60, which comprises the fixture lighting system 40.

FIG. 19 shows how the PVC cylindrical body 60 is cut, preferably by means of a saw 802, to the desired geometry for light-emitting window openings before the stucco 66 is applied. It is to be understood that any means capable of rendering a hole in the surface of the cylindrical body 60 is acceptable and may be applied in situations where a traditional saw 802 might prove less desirable, such as the creation of a circular hole. As has been noted elsewhere in this specification, preferably there are at least two horizontal window openings 61, achieved by the removal of rectangles 98; however, these window openings may be in any shape, including words such as “ENTER”, “EXIT”, or symbols (not shown). Following the removal of material to achieve the desired window openings 61, rectangular or otherwise, the exterior covering material, such as stucco 66, is applied over the surface of the cylindrical body 60, and set aside to cure. This above-shown method embodies herein a method of manufacturing an exterior lighting system article comprised of a substantially hollow cylinder, having a peripheral wall, comprising in combination the steps of: roughening the external peripheral wall of such substantially hollow cylinder; applying stucco to such external roughened peripheral wall; and allowing such stucco to cure. Stucco 66 could be a high quality stucco comprised of Portland cement and hydrated lime, such as SUPERIOR EXTERIOR STUCCO, supplied by PARAGON BUILDING PRODUCTS (TM), of 2895 Hammer Ave., Norco, Calif. 91760. However, it is presently preferred to use an elastomeric acrylic fortified polymer coating material, mixed with assorted sizes of calcium carbonate, quartz, and silica sand aggregates, such as PREMIUM STUCCO by HIGHLAND PRODUCTS (TM). Following curing, the stucco 66 may be painted as desired (not shown). This arrangement with stucco 66 embodies herein a covering means for covering such enclosure means in such manner as to resist environmental degradation and promote aesthetic appeal.

As depicted in FIG. 20, an inspection of the coated cylindrical body 60 is performed, and if necessary, excess coating material may be removed by trimming 902, if deemed necessary, to insure proper fit of the cap and internal lens.

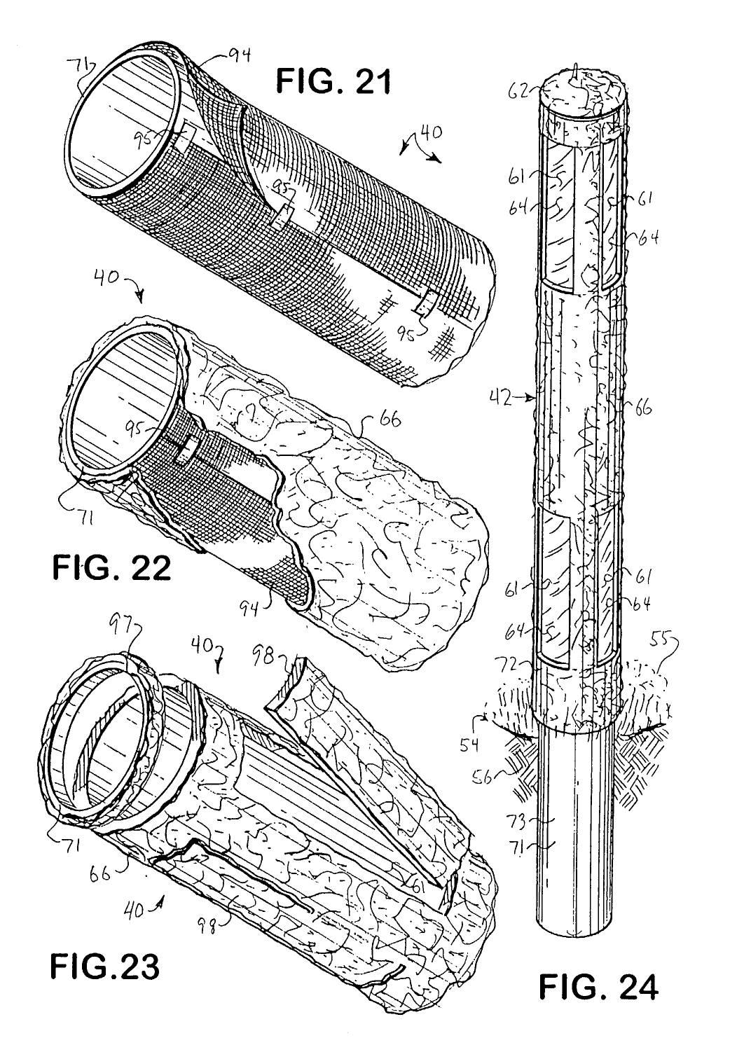

FIG. 21 through FIG. 23 illustrates an alternative means of applying a desired exterior coating to the lighting system, as may be appropriate under certain circumstances, and/or for alternative exterior coatings other than the preferred stucco 66 herein described. FIG. 21 is a partial perspective view of a preferred embodiment of the exterior lighting system 40 showing how screen 94 is installed prior to applying stucco 66.

FIG. 22 is a partial perspective view showing how stucco 66 is applied after installing screen 94. FIG. 23 shows how the stucco-coated PVC pipe 71 is cut to the desired geometry after the stucco 66 is applied. The first step in such installation is to make sure that the outside surface of PVC pipe 71 is clean. Then, as illustrated in FIG. 21, screen 94 is wrapped around PVC pipe 71, as shown, and held in place with tape 95. Screen 94 is preferably standard fiberglass window screen of the type commonly used to keep flying insects from entering an open window of a building. Screen 94 preferably comes on a roll, and has a width equal to the height of the above-ground portion 72 (see FIG. 6) of the exterior lighting system 40 being manufactured. Screen 94 is preferably cut so that it overlaps about an inch, as shown. Next, as shown in FIG. 22, stucco 66 is applied over screen 94, covering screen 94 and tape 95. Then, exterior lighting system is set aside for stucco 66 to cure. Stucco 66 could be a high quality stucco comprised of Portland cement and hydrated lime, such as SUPERIOR EXTERIOR STUCCO, supplied by PARAGON BUILDING PRODUCTS (TM) of 2895 Hammer Ave., Norco, Calif. 91760. However, it is presently preferred to use an elastomeric acrylic fortified polymer coating material, mixed with assorted sizes of calcium carbonate, quartz, and silica sand aggregates, such as PREMIUM STUCCO by HIGHLAND PRODUCTS (TM). After stucco 66 cures, PVC pipe 71 is preferably saw cut through stucco 66, as shown in FIG. 23, to the desired shape. As depicted in FIG. 23, typical cuts include: removing a ring 97 from the top to make the end of PVC pipe 71 (with stucco 66) square; and cutting out rectangles 98 to form windows 61.

As mentioned elsewhere in this specification, various components, such as clips 85 and fasteners 84 (see FIG. 10), can be installed prior to applying the stucco 66. Thus, fasteners 84 and the like will be hidden under stucco 66. Alternatively, fasteners 84 and the like can be installed after applying stucco 66, and stucco 66 can be repaired to hide such fasteners as 84. This above-shown method embodies herein wherein the attachment structure for at least one internal electric lamp is installed within said substantially hollow cylinder prior to coating with said stucco.

FIG. 24 is a perspective view of a preferred embodiment of the pole light 42 of the exterior lighting system 40, further showing how several embodiments of the present invention can be installed directly in soil. As shown, pole light 42 preferably has two rows of four equal-sized windows 61, one row at the top, similar to column light 41 described above, and one row just above ground-level 54 (embodying herein wherein such cylindrical peripheral wall comprises at least two rows of windows structured and arranged to let light out of such substantially hollow enclosure). Pole light 42 preferably has an above-ground portion 72 that is about 72 inches long, and a below-ground portion 73 that is about 18 inches long. Thus, when installed, pole light 42 rises 72 inches above the ground 54, and the total length of PVC pipe 71 is 90 inches. Pole light 42 is preferably made of the same 6-inch nominal diameter PVC pipe 71 as column light 41 described above.

Pole light 42 is preferably coated, preferably with the same stucco 66 as described above and shown in FIG. 24. Although FIG. 24 shows pole light 42 installed directly in soil 56, pole light 42 should preferably be installed in the preferred manner described above for column light 41.

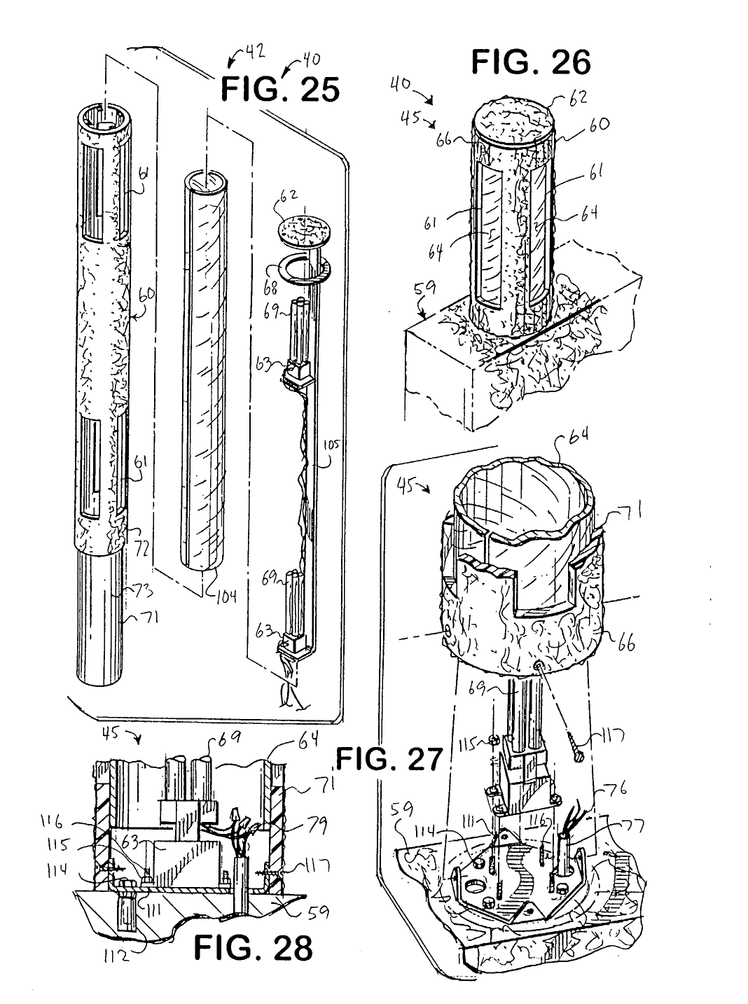

FIG. 25 is an exploded perspective view of a pole light 42 illustrating, for example, the lens 104, and how the two electric lamps 63 are hung from the top end 62. The internal components of pole light 42 are the same as for column light 41 described above, except for the differences noted herein. The main difference is that pole light 42 preferably has two electric lamps 63 for the two rows of windows 61, one lamp for each window row. Lens 104 is longer to cover both rows of windows, and hanger 105 is longer to support both electric lamps 63. Pole light 42 has a coil of electrical wire 91 of wire that is not fully shown, but contains more turns than the coil of electrical wire 91 for column light 41, due to the greater height of the body 60. Accessing of the electric lamps 63 in pole light 42 is the same as for column light 41 described above, except that a ladder may be needed, due to the increased height of body 60 and hanger 105.

FIG. 26 is a partial perspective view of the wall top light 45, which is another preferred embodiment of the exterior lighting system 40.

FIG. 27 is an exploded partial perspective view of the wall top light 45 showing how it is installed.

FIG. 28 is a partial side sectional view of the wall top light 45, also showing how the wall top light 45 is installed. Wall top light 45 is preferably similar to column light 41 described above, except for the differences described herein and shown in the figures. The most obvious differences, as can be seen best in FIG. 26, are that wall top light 45 is shorter and is mounted on the top of a wall 59, rather than being embedded in the ground 54.

As can be seen in FIGS. 27 and 28, wall top light 45 has a base plate 111 end cap that is attached to the top of wall 59, preferably with four expansion anchors 112 and bolts 114. Other fasteners could be used, as well, selectable by a person of ordinary skill in the art. Lamp 63 preferably attaches to base plate 111 with studs 116 and nuts 115. PVC pipe 71, preferably forming the cylindrical body 60, preferably attaches to base plate 111 with four sheet metal screws 117, as shown. Thus, to access lamp 63, and light bulbs 69, one would remove the four screws 117 and lift off the cylindrical body 60.

Alternatively, and under appropriate circumstances, it may be preferred to apply the configuration of the preferred embodiment described above as the viga light 1002 (comprised of a cylindrical body 60, light window opening 61, lens 64, end cap 212, base cap 606, and the preferred exterior coating of stucco 66), for use as a vertical wall top light 45. Such a configuration would be identical in internal construction as described in FIGS. 12 through 17, with the cylindrical body 60 forming the housing and support for the electric lamp 63 and light fixture hanger 65, preferably structured and arranged to attach to the inner sidewall of the cylindrical body 60 by means of the preferred wing-nuts 210 tightened upon the attachment screws 202 embedded in the sidewall of the cylindrical body 60. The placement of the lens 64 is preferably flush with the interior wall of the cylindrical body 60. Additionally, the ends 264 and 265 of the lens 64 nest approximate to the hanger attachment screws 202. Affixture of the base cap 606 to the wall 59 is achieved by whatever means appropriate and selected by the installer, including but not limited to bolting, nailing, screwing, and bonding. Departing from the viga light construction, which preferably has only one window opening 61, this embodiment of the wall top light 45 will preferably have a plurality of window openings 61. The wall top light 45 thus described is an embodiment of the exterior lighting system 40 wherein the enclosure further comprises two end caps, and is structured and arranged for mounting by one end cap to an essentially flat, essentially horizontal surface, with the axis of the enclosure substantially vertical and aligned substantially perpendicular to the horizontal mounting surface.

Wall top light 45 is preferably powered by electrical service wiring 76 in conduit 77, which will have been previously installed in wall 59, preferably as shown. Lamp 63 is preferably connected to electrical service wiring 76 with wire nuts 79. Where the viga style of construction and embodiment of the wall top light 45 selected, no coil of electrical wire 91 is needed for wall top light 45, which light embodies herein that such body is structured and arranged for mounting on an essentially flat, essentially horizontal surface, and wherein such axis of such body is essentially vertical.

FIG. 29 is a partially exploded perspective view of the vertical wall mount light 47 that is another embodiment of the exterior lighting system 40.

FIG. 30 is a sectional side view of the vertical wall mount light 47, showing how the vertical wall mount light 47 is installed on a wall surface 57.

FIG. 31 is a sectional top view of the vertical wall mount light 47, also showing how the vertical wall mount light is installed on a wall surface 57. Vertical wall mount light 47 preferably attaches to the outside vertical wall surface 57 of a building 51 with fasteners 122. Fasteners 122 are shown to be wood screws, which would be the best choice where wall surface 57 is wood. For other wall surface 57 materials, other fasteners 122 may be preferable, and such fasteners 122 would be readily selectable by a person of ordinary skill in the art of attaching things to wall surfaces 57. Vertical wall mount light 47 preferably has a backing plate 120, which is preferably made of a reflective material, such as steel, so that more light is reflected out windows 61. Vertical wall mount light 47 preferably also comprises body 121, which is made of a half-round section of PVC pipe 71, preferably covered with a coating described herein, such as stucco 66, as shown. Body 121 preferably has three windows 61, which are covered with lens 64, as shown (and similarly, to other described embodiments). Body 121 has two ends 123, which are preferably made of plastic or metal sheet attached to body 121, preferably with a suitable adhesive (in ways well-known to a person of ordinary skill in the art of manufacturing articles from plastic and metal). Body 121 attaches to backing plate 120, preferably with four screws 117, as shown. Body 121 can be removed by removing screws 117 to access lamp 63 and light bulbs 69. Electrical power is provided, as shown, and in well-known ways, from the wall area where this embodiment is mounted.

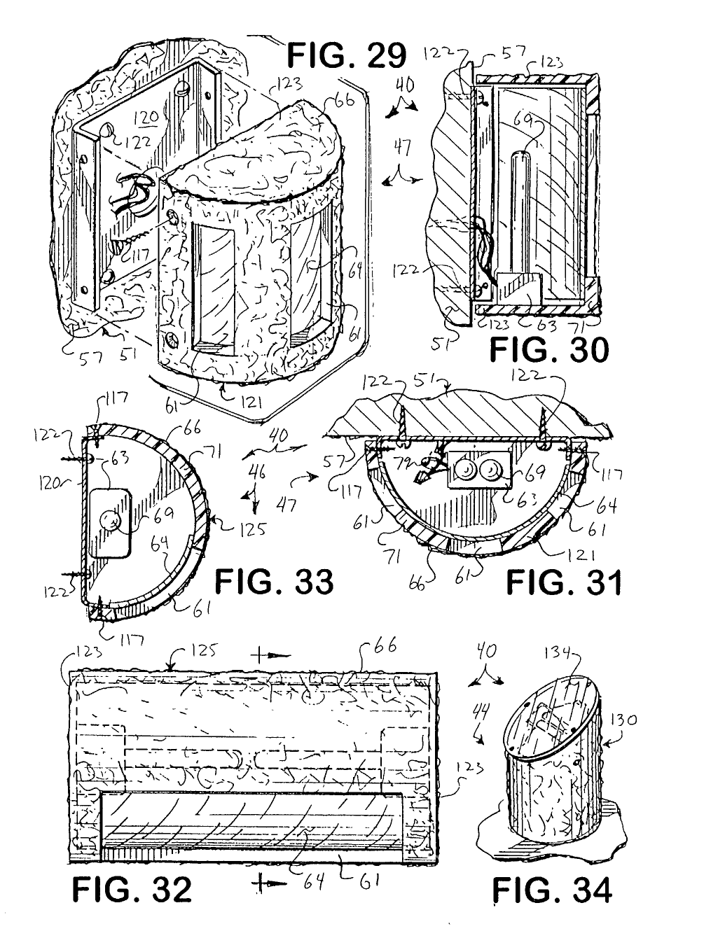

FIG. 32 is a front view of the horizontal wall mount light 46, which is another embodiment of the exterior lighting system 40, wherein enclosure comprises a half-circular cylindrical peripheral wall.

FIG. 33 is a sectional side view of the horizontal wall mount light 46 showing how the horizontal wall mount light is installed on a wall surface 57 of a building 51. Horizontal wall mount light 46 is similar to vertical wall mount light 47, except that it is mounted with the axis of the PVC pipe 71 horizontal, rather than vertical. Another difference is that horizontal wall mount light 46 preferably only has one window, preferably on the bottom half, so that horizontal wall mount light 46 shines its light primarily downward. Horizontal wall mount light 46 also preferably has two electric lamps 63, as shown; and electrical service is again provided from the wall area of the mounting.

FIG. 34 is a perspective view of a preferred embodiment of flood light 44 of the exterior lighting system 40.

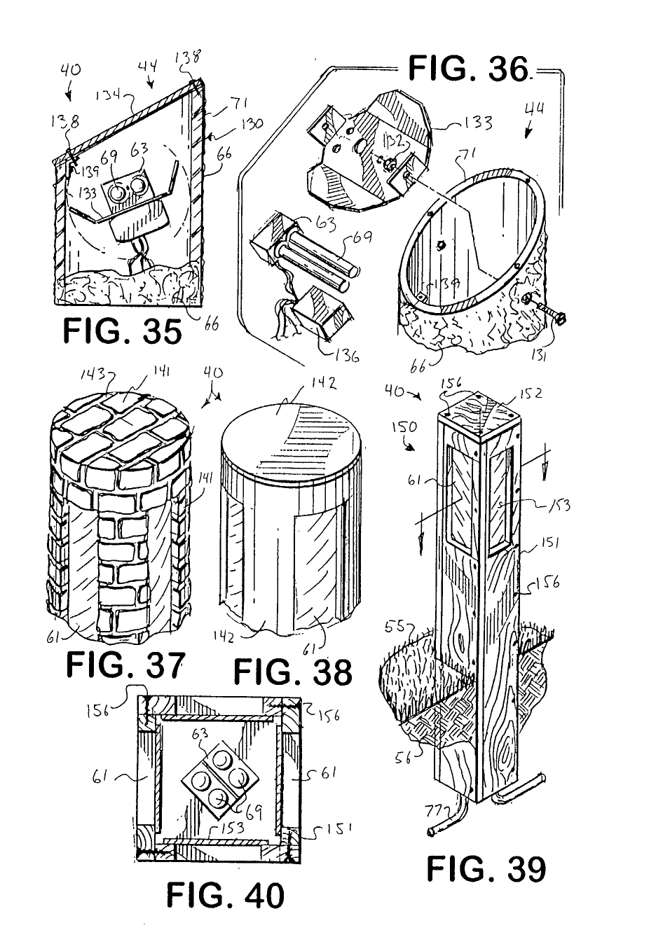

FIG. 35 is a sectional side view of the flood light 44 showing how the lamp 63 and reflector 133 pivot, and how the lens 134 is installed.

FIG. 36 is an exploded partial perspective view of the flood light 44 showing how the lamp 63 and reflector 133 are installed. Flood light 44 is typically mounted close to the ground 54 and is used to light objects, such as buildings 51 or trees 52 (see FIG. 1). Flood light 44 preferably has a lamp 63 with short light bulbs 69, as shown, and a reflector 133. As shown in FIG. 36, lamp 63 preferably has a separate ballast 136. Flood light 44 has a body 130, which is made of PVC pipe 71, as described above, for column light 41. PVC pipe 71 is preferably coated with a material described herein, such as stucco 66, as shown in FIGS. 35 and 36 and described above. Although not shown in FIGS. 35 or 36, flood light 44 preferably mounts directly in the soil 56, as shown in FIG. 24. Due to the short stature of flood light 44, concrete 78, as shown in FIG. 10, is not needed. Flood light 44 preferably has lens 134, which is preferably comprised of an elliptical piece of clear transparent polycarbonate. Lens 134 is preferably set at an angle, as shown in FIG. 35. Lens 134 is preferably set at an angle of about 30 degrees from horizontal, but could advantageously be set at an angle from about 15 degrees, to about 60 degrees from horizontal. [In other words, lens 134 could be set at an angle between 30 and 75 degrees from the axis of PVC pipe 71.] PVC pipe 71 is cut at the angle of lens 134, and lens 134 is attached to body 130 with four screws 138. Three of screws 138 preferably screw directly into holes in PVC pipe 71, and one screw 138 screws into bracket 139, as shown. Lamp 63 and ballast 136 preferably attach to reflector 133, as shown in FIG. 21, and reflector 133 preferably attaches to body 130 (PVC pipe 71) with two screws 131 and two nuts 132, as shown in FIG. 36. Thus, reflector 133 can be pivoted along the line through screws 131 to aim the light at the object being illuminated. Flood light 44 embodies herein wherein such substantially hollow enclosure comprises a circular cylinder, such end cap comprises a lens, with a lens axis perpendicular to a face of such lens, such end cap is mounted at an angle between such lens axis and a central axis of such circular cylinder, wherein such angle is between 30 and 75 degrees.

FIG. 37 is a partial perspective view of an embodiment of the exterior lighting system 40 showing a brick coating 141.

FIG. 38 is a partial perspective view of an embodiment of the exterior lighting system 40, showing a metal sheet coating 142. When made with PVC pipe 71 or other pipe, exterior lighting system 40 is preferably coated with one of several materials. These materials include stucco 66 (see FIGS. 2 through 36), brick 141 (FIG. 37), aluminum sheet (metal sheet 142, FIG. 1 and FIG. 38) copper sheet (metal sheet 142, FIG. 1 and FIG. 38), stone (not shown), tile (not shown) and wood (not shown). Brick, stone, tile, and wood are preferably attached to PVC pipe 71 with a suitable adhesive, readily selectable by a person of ordinary skill in the art, and applied over screen 94, as shown in FIG. 21, and described above. Mortar 143 is preferably applied between bricks or stone (see FIG. 37). Mortar 143 is preferably epoxy mortar. For tile, a high quality grout would preferably be applied between the tiles. Metal sheet 142 (e.g., aluminum or copper) is preferably secured with a suitable adhesive also, but screen 94 is preferably not used with metal sheet 142. The coating (stucco 66, brick 141, metal sheet 142, or others described herein) performs the function of protecting PVC pipe 71, or other pipe, from environmental degradation. Where PVC pipe 71 is used, the chief mechanism of environmental degradation is embrittlement and loss of strength due to the harmful effects of ultraviolet light from the sun. Preventing ultraviolet degradation of PVC pipe 71 is particularly important in sunny climates, such as in Phoenix, Ariz. Where steel pipe is used (described above), the chief mechanism of environmental degradation is corrosion, particularly in wet climates, or where exterior lighting system 40 is installed in a grass lawn 55 that is frequently watered.

FIG. 39 is a perspective view of a preferred embodiment of redwood light 150 of the exterior lighting system 40. FIG. 39 shows how the redwood light 150 is installed.

FIG. 40 is a sectional top view of the redwood light 150 showing how it is constructed, and how the lenses 153 and lamp 63 are installed. Redwood light 150 is preferably comprised of four identical sides 151, as shown, which are preferably each made from 1×8×60 inch redwood boards. The sides are preferably held together with screws 156, as shown, forming a right square cylinder (redwood light 150 embodying herein that such cylinder is essentially a right square cylinder). Screws 156 are preferably drywall screws readily selectable by a person of ordinary skill in the art of carpentry. Each side 151 has an elongated rectangular window 61, as shown, each preferably covered on the inside by a lens 153, as shown. Each lens 153 is preferably a square piece of translucent plexiglass, preferably secured to side 151 with a suitable adhesive. Redwood light 150 preferably also has top end 152, which is also made of redwood board, and is preferably secured by four screws 156, as shown in FIG. 39. Lamp 63 is preferably attached to top end 152 with a hanger 65 (not shown) similar to hanger 65 for column light 41, as shown in FIG. 11 and described above. The connection of lamp 63 in redwood light 150 to electrical service wiring 76 (not shown) is preferably the same as for column light 41, as shown in FIG. 11 and described above. Redwood light 150 can be embedded directly in soil, with or without concrete 78, as shown in FIGS. 8 and 10, and as described above for other embodiments. Although a redwood light similar in size and features to column light 41 is shown on the figures, as can be easily visualized by a person of ordinary skill in the art, such redwood light can be similar in size and features to pole light 42, wall top light 45, vertical wall mount light 47, horizontal wall mount light 46, and flood light 44.

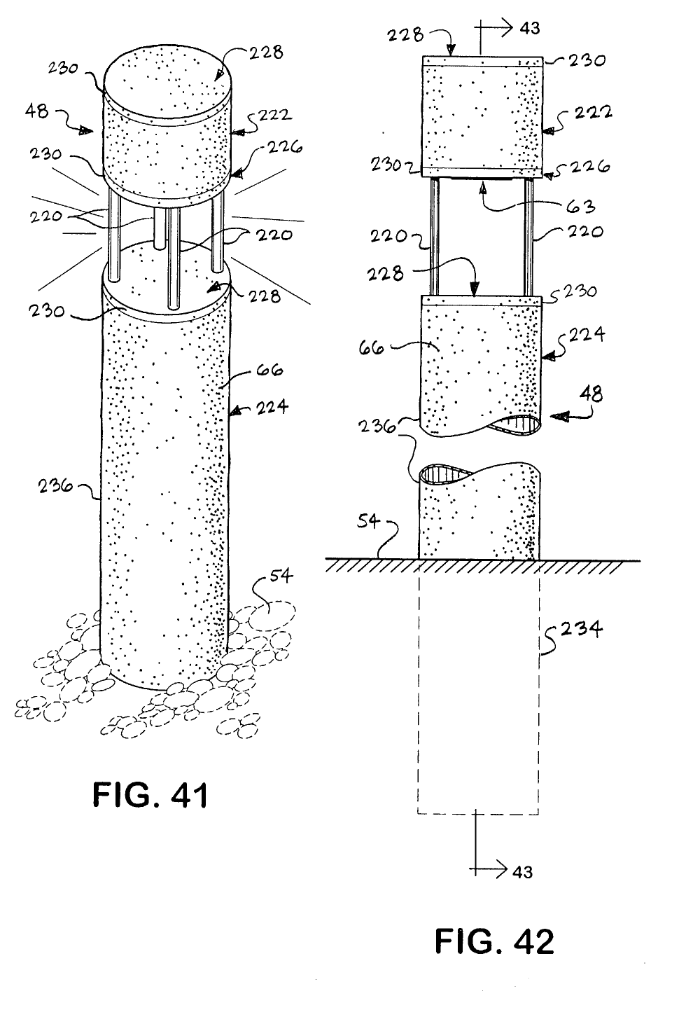

FIG. 41 is a perspective view of a diffuse column light 48 installed in the ground 54. As shown, the diffuse column light 48, is preferably comprised of an upper cylindrical body 222 rigidly attached to a lower cylindrical body 224, preferably, by means of at least 4 rods 220. As shown, there is open space between the lower bottom cap 226 of the upper cylindrical body 222 and the top cap 228 of the lower cylindrical body 224. Preferably, this vertical space is typically in the range of 3 to 6 inches. Electric lamp 63 is embedded in the lower bottom cap 226 such that the emitted light is directed downward to reflect and diffuse off of the top cap 228 affixed to the lower cylindrical body.

FIG. 42 is a side view of the diffuse column light 48 installed in the ground 54, indicating the portion of the lower cylindrical body 224 that is buried in the ground to provide stable mounting.

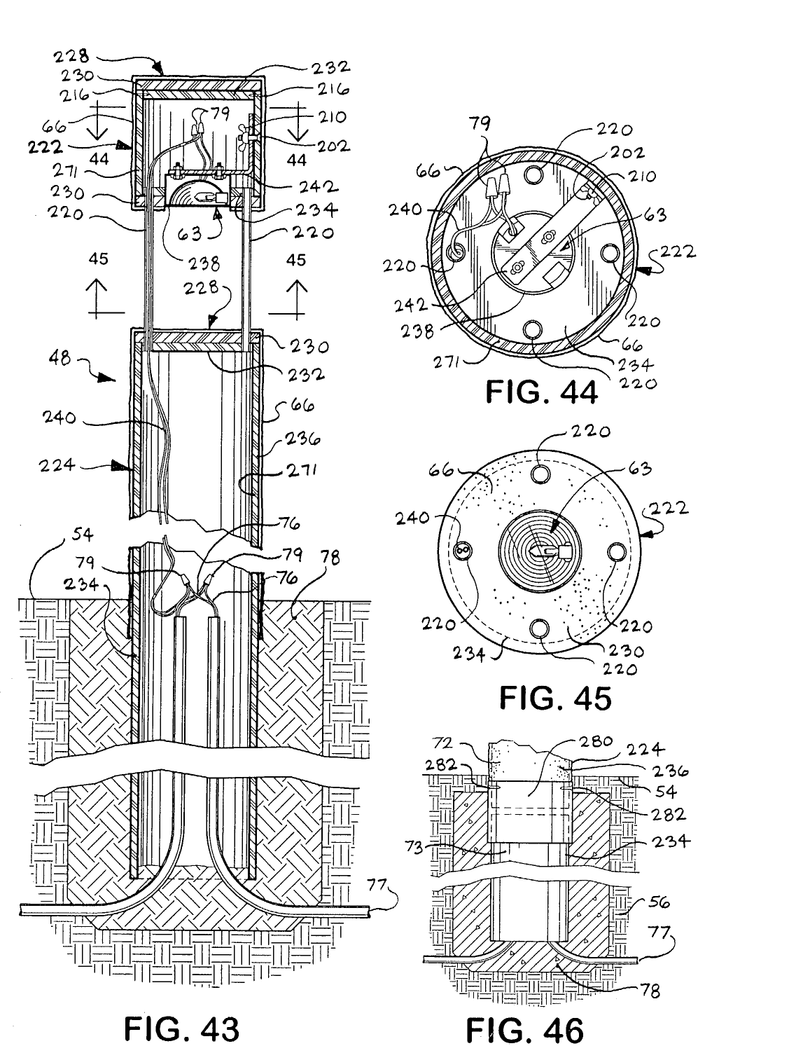

FIG. 43 is a side view, partially in section, cut away of the diffuse column light 48 installed in the ground 54 and illustrating how the various components of the diffuse column light fit together and how the light is attached to the electrical service wiring. As has been described above in relation to other embodiments, the diffuse column light 48 is preferably constructed from polyvinyl chloride (PVC) pipe 271 of a type widely available for domestic and commercial use. Unlike PVC pipe 71 described above, preferably, the PVC pipe 271 used to construct the diffuse column light 48 has an outside diameter of approximately four and a half inches. Under appropriate circumstances, it may be desirable to provide a diffuse column light 48 that is considerably larger in diameter. As will be described in more detail below, diffuse column light 48 is preferably constructed to be installed with a portion of the lower cylindrical body 224 embedded in the ground 54 (below grade). To further weatherproof and provide an aesthetic appearance, a substantial portion of the exterior surface of the enclosure is coated with a covering, which is structured and arranged from a group consisting of stucco, brick, stone, tile, copper sheet, aluminum sheet, stainless steel, iron sheet, and wood. The below-ground portion 234 of the lower cylindrical body 224 of diffuse column light 48 is preferably not coated (i.e., no stucco 66), while the above-ground portion of diffuse column light 48 is preferably coated, and is shown in FIGS. 41 and 42 coated with stucco 66.

The below-ground portion 234 of diffuse column light 48 is preferably about 18 inches long. The above-ground portion 236 of diffuse column light 48 can be many different sizes. In a preferred embodiment of the present invention, the below-ground portion 234 of the diffuse column light 48 may further comprise a coupling 280 (see FIG. 46), preferably a slip coupling, preferably a PVC slip coupling, permitting temporary removal of the above-ground portion 236 without excavation. Preferably the coupling 280 is permanently attached to the lower section of the below-ground portion 234 of the diffuse column light 48. Such temporary removal of the above-ground portion 236 of the diffuse column light 48 may be desired to provide direct access to the electrical service wiring 76 (as the preferred inner diameter of the diffuse column light 48 is approximately 4 inches), or replacement of the above-ground portion 236 of the diffuse light 48 should it become damaged.

Preferably, when the below-ground coupling 280 is used, concrete 78 is utilized to further support and stabilize the diffuse column light 48. To help deter theft of the diffuse column light 48 and provide greater structural rigidity, preferably the concrete 78 is not brought to grade level, rather there is sufficient clearance between the top of the concrete 78 pour and ground level 54 to enable the use of screws 282. Preferably, screws 282 extend through the sidewalls of the coupling 280 and into side walls of the lower cylindrical body 224. Preferably, soil 56, lawn grass (not shown) or other matching surface covering is used to cover screws 282.

For typical installations, applicant's preferred length for the above-ground portion 236 of diffuse column light 48 is about 24 inches. Thus, a preferred overall length of PVC pipe 271 for diffuse column light 48 is about 52 inches. PVC pipe 271 embodies herein, as shown, a fixture comprised of a first and second substantially hollow right cylinder enclosures having exterior and interior surfaces, of substantially the same diameter, structured and arranged to form a solid light fixture. More specifically, each enclosure has a peripheral wall, a longitudinal axis, at least a substantial portion of each said peripheral wall being circular, and each enclosure being structured and arranged to enclose said electrical connections. Further, each enclosure has end caps structured and arranged to cap the top ends of the first and second enclosures, and the first enclosure has a bottom cap structured and arranged to cap the bottom of the first enclosure. The enclosures are rigidly attached along their mutual longitudinal axis' by mounts structured and arranged between the end cap of the second enclosure and the bottom cap of the first enclosure for mounting the first said enclosure directly above, and proximate to, the top of the second enclosure.

As shown in FIG. 43, the top caps 228 are comprised of two planer disks, a top exterior disk 230 that is the same diameter as the exterior of the cylindrical bodies 222 and 224, respectively, and an interior plug disk 232 with a diameter approximate to the interior diameter of the cylindrical body so as to achieve a snug fit. Preferably, the exterior disk 230 is coated with the same outer covering material, such as stucco 66, that has been applied to the exterior of the diffuse column light 48. The interior plug disk 232 is centered and attached to the underside of the exterior disk 230 such that the assembled top cap 228 preferably fits snugly and flushly atop the lower cylindrical body 224 and the upper cylindrical body 222. When assembled, preferably, the top cap 228 is approximately ½ inch thick. The lower bottom cap 226 is constructed with the identical components to top caps 228 (exterior disk 230 and interior plug disk 232).

Setting it apart from the top caps 228, the lower bottom cap has a central hole 238, which is used in the mounting of the electric lamp 63. Preferably, the electric lamp is inset into the lower bottom cap, as shown in FIG. 43, however, under appropriate circumstances, it may be desirable to mount the electric lamp entirely within the upper cylindrical body such that the light emanates through the central hole 238 in a manner similar to the window opening illumination described above. Although far less preferred, under still other appropriate circumstances, it may be desirable to mount the electric lamp 63 to the exterior of the lower bottom cap 226, directly over the central hole 238. As shown in FIGS. 43 and 45, a light fixture hanger 242 is provided within the upper cylindrical body 222. The light fixture hanger 242 attachment is preferably comprised of a screw 202, preferably embedded in the sidewall of the upper cylindrical body 222 (as shown in FIG. 4), such that the threads of the screw 202 protrude from the interior sidewall of the upper cylindrical body 222 with sufficient clearance to accommodate the light fixture hanger 242, and wing-nut 210. The exterior portion of the screw 202 is covered with the exterior covering, such as stucco 66, so as to be hidden from view. Under appropriate circumstances, other attachment means may be substituted. Moreover, at least one attachment is structured and arranged to attach the electric lamp to the bottom of the first enclosure, wherein the electric lamp is attached internally, externally or partially embedded in the bottom cap of the first enclosure. In this configuration the light from the electric lamp is directed downward upon the top of the lower enclosure, and thus, achieves defuse lighting. Preferably, the electric lamp intended for the diffuse column light 48 fixture is the black 20 watt 120 volt halogen cabinet light, as manufactured by Hampton Bay, and available from the Home Depot™ under SKU# 153270/UPC# 034378310065. Under appropriate circumstances, a similar low voltage electric lamp may be substituted.

As shown in FIGS. 43, 44 and 45, the rods 220 are rigidly, vertically embedded through the top cap 228 for the lower cylindrical body and the lower bottom cap 226. Preferably, at least one of the rods 220 is hollow, permitting the internal electrical wiring 240, connected to the electrical service wiring 76, preferably with wire nuts 79, to pass from the lower cylindrical body 224 into the upper cylindrical body 222 without exterior exposure, and therein, connect to the electric lamp, preferably, by additional wire nuts 79. Electrical service wiring 76 is preferably installed, either in conduit 77 as shown, or without conduit (direct burial—not shown). Installation of the diffuse column light 48 in the ground 54 is akin to the description provided above with regard to FIGS. 8 and 10. Under appropriate circumstances, concrete 78 may be used to help further stabilize the diffuse column light 48.

Preferably, the top cap 228 fit upon the lower cylindrical body, and the lower bottom cap 226 fit upon the upper cylindrical body 222 are attached to their respective cylindrical bodies with a suitable attachment means (screws, bonding agent, heat welding, etc . . . ) such that the integrity of the diffuse column light 48 is assured.

To provide access to the electric lamp 63, internal electrical wiring 240, light fixture hanger 242 and electric lamp 63, top cap 228 is held in place on the upper cylindrical body 222 by screws 216, which extend through the sidewalls of the upper cylindrical body 222 and into the interior plug disk 232 of the top cap 228.

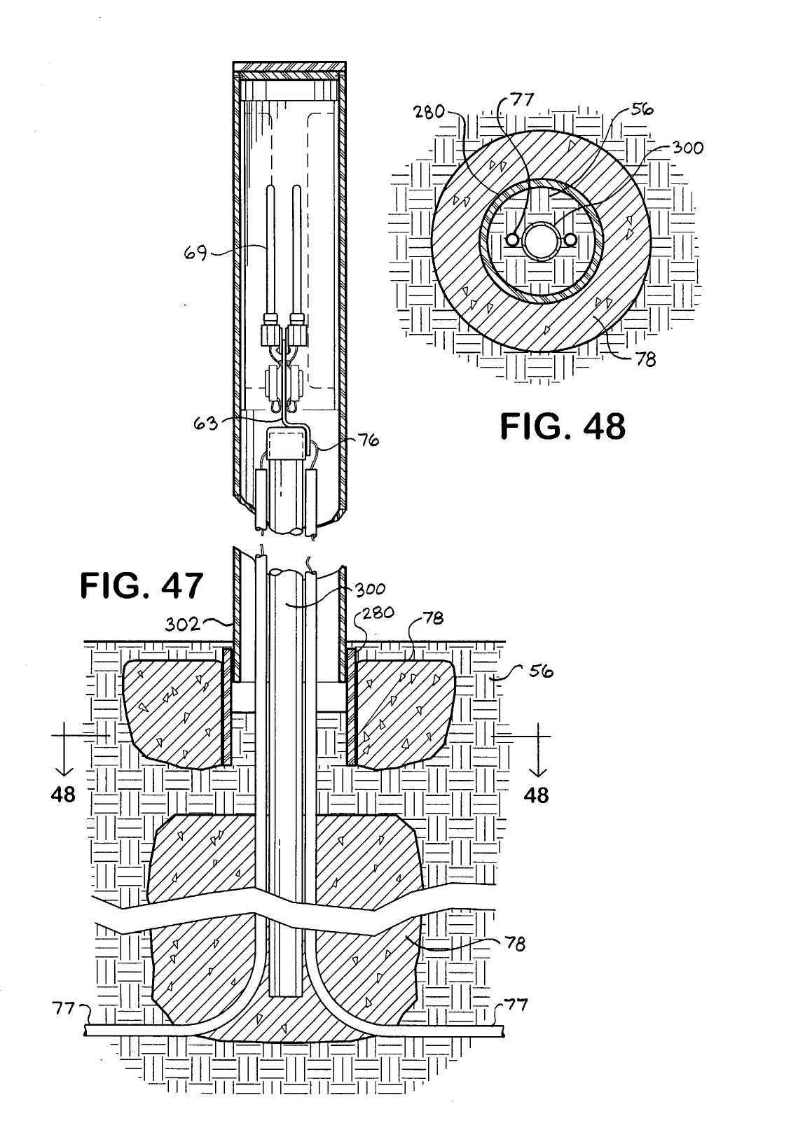

FIG. 47 and FIG. 48 show an alternate embodiment of the present invention in which the light is vibration-isolated from the enclosure. Preferably, electric lamp 63 is attached to mount 300 which is attached and extends below ground. Preferably, bottom end of mount 300 is placed directly in soil 56 and reinforced with concrete 78 for added stability, as shown. Preferably mount 300 is not attached or connected to hollow enclosure 302, and therefore impacts upon hollow enclosure 302 and vibrations therefrom, which could be potentially damaging, will not be transferred to electric lamp 63 and lightbulbs 69. Preferably, lamp 63 and everything else attached to mount 300 is isolated from and does not contact hollow enclosure 302 above ground, as shown. Preferably mount 300 is separated from hollow enclosure 302 by soil 56, which absorbs impacts and vibrations. Preferably, conduit 77 is attached to mount 300 as shown, or within mount (not shown). Preferably, concrete 78 reinforcing the mount 300 is not integral with concrete 78 reinforcing the hollow enclosure 302 (or coupling 280), but rather separated by soil 56. Preferably, hollow enclosure 302 extends below and is mounted directly in the ground. Under appropriate circumstance hollow enclosure may include coupler 280, as shown. The above embodying herein at least one mount structured and arranged to mount such at least one internal electric lamp; wherein such at least one mount extends below ground; and wherein such at least one mount does not contact such substantially hollow enclosure above ground and further embodying wherein said at least one mount is substantially isolated from said substantially hollow enclosure by the ground.

FIG. 49, FIG. 50 and FIG. 51 illustrate how a preferred embodiment of the column light can be used as a fence post. Preferably, chain, cable 304, or similar line is attached to a fencing attachment 306 on the end cap 212 to provide a fence 310 or similar barrier, as shown in FIG. 50. Under appropriate circumstances fencing attachment 306 may also be located at other locations on hollow enclosure 302. The above arrangement embodying wherein such substantially hollow enclosure comprises at least one fencing attachment and also embodying wherein such at least one end cap comprises at least one fencing attachment.

Although applicant has described applicant's preferred embodiments of this invention, it will be understood that the broadest scope of this invention includes such modifications as diverse shapes and sizes and materials. Such scope is limited only by the below claims as read in connection with the above specification. Further, many other advantages of applicant's invention will be apparent from the descriptions and the claims.

What is claimed is:

1. An exterior lighting system, for use in an environment having electrical service wiring, comprising in combination:
a) at least one internal electric lamp,
i) structured and arranged to receive at least one light bulb, and
ii) having electrical connections for the electrical service wiring;
b) a substantially hollow enclosure, structured and arranged to house said at least one electric lamp and said electrical connections;
c) wherein said substantially hollow enclosure comprises,
i) a cylindrical peripheral wall, having an upper end and a lower end,
ii) at least one end cap mounted on said upper end,
iii) wherein said lower end of said cylindrical peripheral wall extends below ground thereby assisting in stably mounting said substantially hollow enclosure directly to the environment.

2. The exterior lighting system according to claim 1 wherein said lower end is structured and arranged for mounting to the environment without use of any anchor bolts.

3. The exterior lighting system according to claim 1 further comprising at least one attacher structured and arranged to attach said at least one internal electric lamp to said substantially hollow enclosure.

4. The exterior lighting system according to claim 1 wherein a substantial portion of said peripheral wall is circular.

5. The exterior lighting system according to claim 1 further comprising,
a) at least one mount structured and arranged to mount said at least one internal electric lamp;
b) wherein said at least one mount extends below ground; and
c) wherein said at least one mount does not contact said substantially hollow enclosure above ground.

6. The exterior lighting system according to claim 5 wherein said at least one mount is substantially isolated from said substantially hollow enclosure by the ground.

7. The exterior lighting system according to claim 1 wherein a substantial portion of said cylindrical peripheral wall comprises a material selected from the group consisting of stucco, brick, stone, tile, and wood.

8. The exterior lighting system according to claim 1 wherein said at least one end cap is structured and arranged to provide access to said at least one internal electric lamp.

9. The exterior lighting system according to claim 1 wherein said lower end further comprises a coupler structured and arranged to allow removal of a substantial above ground portion of said substantially hollow enclosure without removal of a below ground portion of said substantially hollow enclosure.

10. The exterior lighting system according to claim 1 wherein said at least one end cap is structured and arranged as a rounded sphere, bowl, handle, dispenser, or adornment.

11. The exterior lighting system according to claim 1 wherein said substantially hollow enclosure comprises at least one fencing attachment.

12. The exterior lighting system according to claim 10 wherein said at least one end cap comprises at least one fencing attachment.

13. The exterior lighting system according to claim 1 wherein said electrical connections are structured and arranged to include a coil of electrical wire structured and arranged to fit concentrically within said unitary substantially hollow right cylinder enclosure and allowing the removal of said at least one internal electric lamp without disconnection from the electrical service wiring.

14. The exterior lighting system according to claim 1 wherein said cylindrical peripheral wall comprises at least two rows of windows structured and arranged to let light out of said substantially hollow enclosure.

15. The exterior lighting system according to claim 1 wherein:
a) said substantially hollow enclosure comprises a circular cylinder,
b) said end cap comprises a lens, with a lens axis perpendicular to a face of said lens,
c) said end cap is mounted at an angle between said lens axis and a central axis of said circular cylinder, and
d) wherein said angle is between 30 and 75 degrees.

16. An exterior lighting system, for use in an environment having electrical service wiring, comprising in combination:
a) at least one internal electric lamp,
i) structured and arranged to receive at least one light bulb, and
ii) having electrical connections for the electrical service wiring;
b) a substantially hollow enclosure, structured and arranged to house said at least one electric lamp and said electrical connections;
c) wherein said substantially hollow enclosure comprises a cylindrical peripheral wall;
d) at least one window lens structured and arranged to let light out of said substantially hollow enclosure; and
e) at least one attacher structured and arranged to attach said at least one internal electric lamp to said substantially hollow enclosure.

17. The exterior lighting system according to claim 16 wherein said at least one attacher is further structured and arranged to hold said at least one window lens against an interior surface of said substantially hollow enclosure.

18. The exterior lighting system according to claim 16 further comprising:
a) at least one end cap mounted on a first end of said cylindrical peripheral wall;
b) wherein said at least one attacher comprises at least one bracket, having a first bracket end and a second bracket end;
c) wherein said first bracket end of said bracket is attached to said end cap, said second bracket end of said bracket is attached to said electric lamp, and wherein said end cap, said bracket, and said lamp are structured and arranged to be detachably removed as a unit.

19. An exterior lighting system, for use in an environment having electrical service wiring, comprising in combination:
a) at least one internal electric lamp,
i) structured and arranged to receive at least one light bulb, and
ii) having electrical connections for the electrical service wiring;
b) a substantially hollow enclosure, structured and arranged to house said at least one electric lamp and said electrical connections;
c) wherein said substantially hollow enclosure comprises a half-circular cylindrical peripheral wall.

20. An exterior lighting system, for use in an environment having electrical service wiring, comprising in combination:
a) at least one internal electric lamp,
i) structured and arranged to receive at least one light bulb, and
ii) having electrical connections for the electrical service wiring;
b) a substantially hollow enclosure, structured and arranged to house said at least one electric lamp and said electrical connections;
c) wherein said substantially hollow enclosure comprises,
i) plastic pipe, and
ii) stucco.

21. A method of manufacturing an exterior lighting system article comprised of a substantially hollow cylinder, having a peripheral wall, comprising in combination the steps of:
a) roughening the external peripheral wall of said substantially hollow cylinder;
b) applying stucco to said external roughened peripheral wall; and
c) allowing said stucco to cure.

22. The method according to claim 30 wherein the attachment structure for at least one internal electric lamp is installed within said substantially hollow cylinder prior to coating with said stucco.
